(19) United States
(12) Patent Application Publication
(10) Pub. No.: US 2005/0240558 A1
(43) Pub. Date: Oct. 27, 2005

(54) Virtual server operating on one or more client devices

(76) Inventors: Reynaldo Gil, Cupertino, CA (US); Chochain Lee, Cupertino, CA (US)

Correspondence Address: Philip W. Woo;SIDLEY AUSTIN BROWN & WOOD LLP, Suite 2000, 555 California Street, San Francisco, CA, 94104-1715, US

(21) Appl. No.: 11/105,868

(22) Filed: Apr. 13, 2005

Related U.S. Application Data
(60) Provisional application No. 60/561,786, filed on Apr. 13, 2004.

(51) Int. Cl. G06F 17/30

(52) U.S. Cl. 707/1

(57) ABSTRACT

In one embodiment of the present invention, a computer system includes at least one web server having content that is personalized for a user. A user device, operable to be used by the user, has a browser application and a virtual server application. The browser application is operable to retrieve the personalized content from the at least one web server upon a first request by the user. The virtual server application to provide the personalized content to the browser application upon a second request by the user.

### CROSS-REFERENCE TO RELATED APPLICATION

This application claims priority from provisional U.S. application No. 60/561,786, filed on Apr. 13, 2004, the entirety of which is incorporated by reference herein.

### TECHNICAL FIELD OF THE INVENTION

This invention relates to computer systems and architectures, and more particularly, to a virtual server operating on one or more client devices.

### BACKGROUND

The Internet is an interconnection of computer “clients” and “servers” located throughout the world and exchanging information according to Transmission Control Protocol/Internet Protocol (TCP/IP), Internetwork Packet eXchange/Sequence Packet exchange (IPX/SPX), AppleTalk, or other suitable protocol. The Internet supports the distributed application known as the “World Wide Web.” Web servers maintain websites, each comprising one or more web pages at which information is made available for viewing. Each website or web page can be identified by a respective uniform resource locator (URL) and may be supported by documents formatted in any suitable language, such as, for example, hypertext markup language (HTML), extended markup language (XML), or standard generalized markup language (SGML). Clients may locally execute a “web browser” program. A web browser is a computer program that allows the exchange of information with the World Wide Web. Any of a variety of web browsers are available, such as NETSCAPE NAVIGATOR from Netscape Communications Corp., INTERNET EXPLORER from Microsoft Corporation, and others that allow convenient access and navigation of the Internet. Information may be communicated from a web server to a client using a suitable protocol, such as, for example, HyperText Transfer Protocol (HTTP) or File Transfer Protocol (FTP).

The World Wide Web (WWW) was originally designed for public sharing of electronic documents stored on the various web servers as static files (static web pages). Each static file on a server is assigned a respective URL. A web browser and/or smart web client application, running on a client device, retrieves and views file-based documents addressed with the unique URL. Each file has expiration information determined by the source web server. Multiple servers could be used to provide the files to construct a single web page viewable in the browser program. One of the limitations of this basic web architecture is that it requires users to remain connected to the source (web server) of the information at all times. The use of the web information and application is not easily available while disconnected from the World Wide Web unless the user specifically saves pages or downloads files to a specific directory for offline use or by a mobile application resident on the client device designed for processing data while disconnected. This introduces problems of performance, security, and auditing for the providers of web application and information services. Furthermore, the original web model is not optimized for delivering localized, personalized, and interactive database application and information services on a global scale designed to support local languages, customs, and information.

### SUMMARY

According to an embodiment of the present invention, a computer system includes at least one web server having content that is personalized for a user. A user device, operable to be used by the user, has a browser application and a virtual server application. The browser application is operable to retrieve the personalized content from the at least one web server upon a first request by the user. The virtual server application to provide the personalized content to the browser application upon a second request by the user.

### BRIEF DESCRIPTION OF THE DRAWINGS

For a more complete understanding of the present invention and for further features and advantages, reference is now made to the following description taken in conjunction with the accompanying drawings, in which:

FIG. 1 is a diagram of a web architecture implementation.

FIG. 2 illustrates techniques of synchronization and compression for the web architecture implementation of FIG. 1.

FIG. 3A illustrates a potential problem of single point of failure/bottleneck in a web architecture implementation.

FIG. 3B illustrates a potential problem of managing replicated content in a web architecture implementation.

FIG. 4 illustrates customer personalization in a public Internet setting.

FIG. 5 illustrates other problems of the web architecture implementation of FIG. 1.

FIG. 6 illustrates private enterprise-scale demand-driven personalization.

FIGS. 7A and 7B are diagrams illustrating the economics for web application platforms.

FIG. 8 is a diagram of one web architecture implementation for server-side private applications, according to an embodiment of the present invention.

FIG. 9 is a diagram of another web architecture implementation for server-side private applications, according to an embodiment of the present invention.

FIG. 10 is a diagram for use of a web architecture implementation for virtual private personalized application, according to an embodiment of the present invention.

FIG. 11 illustrates use of a virtual server application in a typical enterprise scenario, according to an embodiment of the present invention.

FIG. 12 is a block diagram of a microchip implementation for a virtual server application, according to an embodiment of the present invention.

FIG. 13 illustrates scalable deployment of a virtual server application for demand driven personalization, according to an embodiment of the present invention.

FIGS. 14A and 14B are diagrams illustrating implementations for management, storage, and configuration components for a virtual server application, according to embodiments of the present invention.

FIG. 15 is a diagram for an exemplary runtime infrastructure for servers and devices, according to an embodiment of the present invention.

FIGS. 16A and 16B illustrate the virtualization of various layers of multiple web transactions, according to an embodiment of the present invention.

FIG. 17 is illustrates multiple virtual web management, according to an embodiment of the present invention.

FIG. 18 illustrates exemplary domain objects, according to an embodiment of the present invention.

FIGS. 19A through 19G illustrate exemplary use cases, according to embodiments of the present invention.

FIGS. 20A and 20B illustrate exemplary sequence diagrams, according to embodiments of the present invention.

FIG. 21 is a diagram illustrating expected scalabity of a web architecture implementation, according to an embodiment of the present invention.

FIG. 22 illustrates an exemplary platform, according to an embodiment of the present invention.

### DETAILED DESCRIPTION

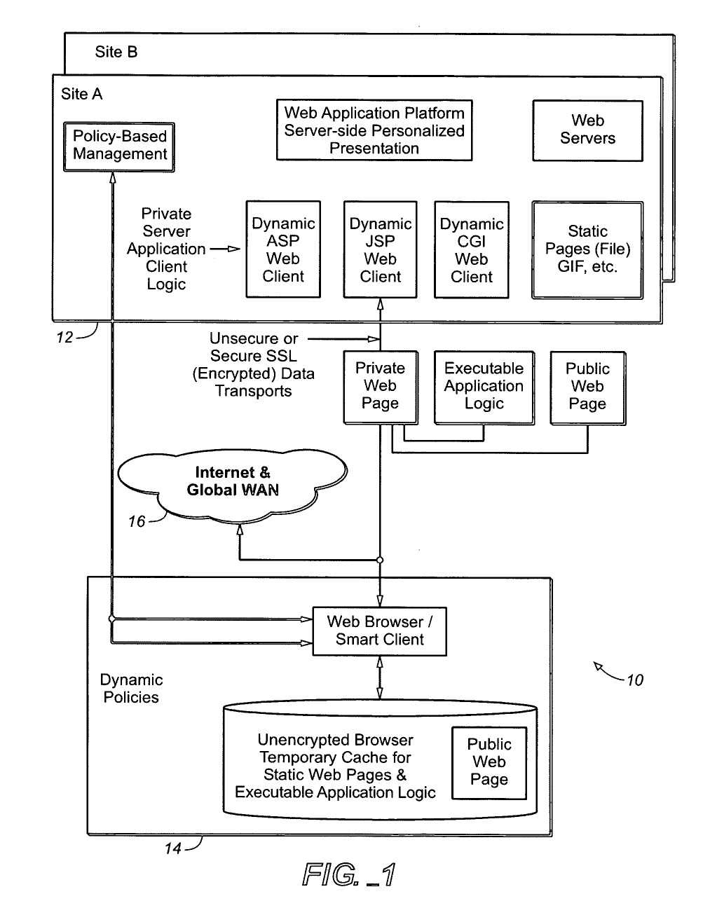

The embodiments of the present invention and their advantages are best understood by referring to FIGS. 1 through 22 of the drawings. Like numerals are used for like and corresponding parts of the various drawings.

Turning first to the nomenclature of the specification, the detailed description which follows is represented largely in terms of processes and symbolic representations of operations performed by conventional computer components, such as a local or remote central processing unit (CPU), processor, server, or other suitable processing device associated with a general purpose or specialized computer system, memory storage devices for the processing device, and connected local or remote pixel-oriented display devices. These operations may include the manipulation of data bits by the processing device and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For purposes of this discussion, a process, method, routine, or sub-routine is generally considered to be a sequence of computer-executed steps leading to a desired result. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for computer operations, and that these terms are merely conventional labels applied to physical quantities that exist within and during operation of the computer.

It should also be understood that manipulations within the computer system are often referred to in terms such as adding, comparing, moving, searching, or the like, which are often associated with manual operations performed by a human operator. It must be understood that no involvement of the human operator may be necessary, or even desirable, in the present invention. The operations described herein are machine operations performed in conjunction with the human operator or user that interacts with the computer or system.

In addition, it should be understood that the programs, processes, methods, and the like, described herein are but an exemplary implementation of the present invention and are not related, or limited, to any particular computer, system, apparatus, or computer language. Rather, various types of general purpose computing machines or devices may be used with programs constructed in accordance with the teachings described herein. Similarly, it may prove advantageous to construct a specialized apparatus to perform one or more of the method steps described herein by way of dedicated computer systems with hard-wired logic or programs stored in non-volatile memory, such as read-only memory (ROM).

FIG. 1 is a diagram of a web architecture implementation 10. This web architecture implementation 10 includes centralized web computing resources 12 and one or more client computers 14 connected by a communication network 16. The centralized web computing resources 12 may include multiple sites (e.g., Site A and Site B), each of which may comprise various hardware, software, and information for web computing. As shown, this hardware, software, and information may include one or more web servers, web application platforms, and static pages. Each static page or file on the web servers is assigned a unique address called a URL (Uniform Resource Locator). Communication network 16 can include any portion of one or more suitable networks for communicating information or data. For example, such a network can be the Internet or a global wide area network (WAN). Each client computer 14 can comprise a browser application, smart client application, personal computer (PC), or other device or software. The web browser and/or smart web client application may act as a general-purpose thin client document viewing application used to navigate and browse through the World Wide Web network of web servers to find, retrieve and view file-based documents addressed with a unique URL. Multiple web servers at the centralized web computing resources 12 may provide the files to construct a single page viewable in the browser application or client computer 14. Each file may have expiration information determined by the source web server so the browser application or client computer 14 knows whether to check and retrieve a fresh (updated) copy of a file or use a locally cached copy previously fetched from the same URL. This simple caching mechanism is employed to reduce server traffic and improve response times.

One of the limitations of the web architecture implementation 10 of FIG. 1 is that it requires users (client computers 14) to remain connected to the source of the information (centralized web computing resources 12) for the duration of interactive sessions with applications and databases. The web information and applications are not readily available when the client computer 14 is disconnected from the centralized web computing resources 12, unless the user or a mobile application (resident on the client computer 14) specifically saves pages or downloads files to a specific directory for offline use or for processing data while disconnected. This necessity for client computers 14 to maintain connections to multiple servers poses security, auditing and performance problems.

The basic connection-oriented, file browsing/retrieving web architecture implementation 10 can be extended with dynamic scripts emulating files as a form of reusable, interactive web client application. The scripts generate a temporary or permanent file “on the fly” based on each unique request string of query parameters, security tokens and user identification information sent to the script object stored as a file on the web server. This basic web scripting model has been extended over the years to produce dynamic files of various types (e.g., common gateway interface (CGI), PERL, Active Server Pages (ASP), Java Server Pages (JSP), and others) acting as a gateway to application and database logic. As shown in FIG. 1, the scripts can include, for example, server-side web private applications or private server application client logic, such as, ASP web client, dynamic JSP web client, and dynamic CGI web client. This executable application logic and dynamic web pages are generated repeatedly on the web server and downloaded to the browser application at the client computer 14 for every request. The browser application retrieves other linked pages or may use static cached pages to assemble page views for each user request.

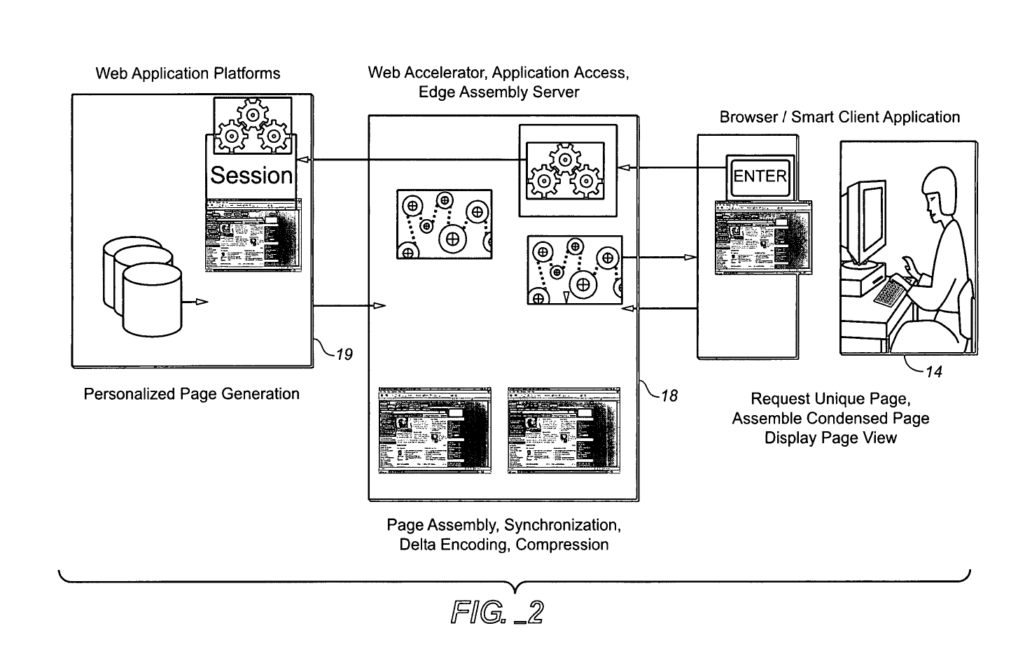

With reference to FIG. 2, the dynamically generated files can consist of a unique combination of content from databases, file systems and application logic based on a specific set of request parameters sent to one or more web servers from the browser or smart client application on the user's client computer 14. A web accelerator, application access, or edge assembly server 18 may perform the functions of assembling the dynamic page, synchronization, delta encoding, and compression. For this, the server 18 may retrieve or use data and applications maintained at web application platforms 19. The server 18 and platform 19 can be part of the centralized web computing resources 12 (seen in FIG. 1).

The request of a user can be personalized by tracking cookies on the user's client computer 14. Tracking cookies—which are capable of identifying a session with a user, but not necessarily who or where the user is—are being turned off by consumers due to concerns over privacy and security affecting the behavior of the web applications. Many web applications cannot function without the tracking cookies. The scripts have been further extended to support not only the downloading of data, but also the uploading of data of various formats. For example, a form can be downloaded to the browser application, data fields can be filled in by a user at the client computer and uploaded to a server script for processing using the POST method.

The browser application has also evolved to load executable files consisting of scripts developed in various browser supported languages (JavaScript, VBScript, Shockwave and others). These executable scripts and programming objects are stored and accessed as files by the browser to provide interactive navigation and other dynamic application behaviors. The loading of executable scripts and objects in the browser client application was designed to reduce the repetitive execution of functions such as navigating, searching, graphics and form handling. A script can be downloaded into the browser application to execute the logic repeatedly without the need for round trips to the server.

The evolution of web architecture to support dynamically generated files, whether executable scripts on the server or browser side, has been prompted by, for example, commercial interests to publish product catalogs (either private, personalized ones or mass-produced, public ones) and generate electronic orders based on product selection from catalog data. A positive user experience could mean increased sales due to ease of use and good shopping performance. Poor application performance for the end user, due to network or application delays, results in abandonment of the application, lost sales and customers.

The web has also been extended to provide many structured database catalogs of information delivered as premium or public information and application services used by the public or in private by authorized business, government and consumer users. In particular, the lack of personalized services from commercial sites has reduced the effectiveness of the mass-marketing sites which publish general-purpose information. Thus, the web model has evolved from one using the mass-marketing techniques to one which uses mass-customization.

Referring again to FIG. 1, browser-based computing device (client computer 14) may have a local cache, originally intended for static file data used during online sessions. Various forms of browser cache management techniques can be employed to reduce the risk of storing confidential data in the browser cache. The web server at the centralized web computing resources 12 sends the file to the browser application with a header containing action instructions. Possible actions which can be taken by the client computer 14 include no cache, no store and short expiration timeouts to prevent the browser application from caching private sensitive data for extended periods of time. Public static (unchanging) data is frequently allowed to be cached in the browser application to reduce the service latencies. Typically, only static files such as graphic images or scripts that do not contain sensitive private data are allowed to be cached using these mechanisms. This mechanism is implemented at each web server, causing many possible inconsistencies between the various servers used to deliver information with inconsistent policies. Each web server may modify the headers with different expiration, cookie security, and other policies. It is difficult to implement a consistent expiration and security policy covering an entire application or database site due to the multitude of web servers involved in providing static and dynamic files of many types. In many cases, there are servers managed by multiple parties providing information and application logic to form a viewable dynamic page or sequence of pages (see also FIG. 2B).

For public shareable files, whether static or dynamic, a shared centralized server-based cache or compression server or appliance (such as web accelerator, application access, or edge assembly server 18 shown in FIG. 2) can reduce the time and cost for generating a web page. However, the server-based or appliance mechanisms do not reduce round trip network and session delays caused by fluctuating network and server load conditions. This web architecture implementation 10 can only support connected users, not users working on portable and/or mobile client computers which are disconnected from the centralized web computing resources 12. There are many other potential failures accessing the information due to dependencies on other web architecture application layer services including DNS (Domain Name Service) for lookups of links prior to access by the browser application. These other web architecture components can be single points of failure, causing page load failures visible to the user (which require intervention by the user to refresh pages or take other action). With proper care the public shared caches can serve the same non-private data to hundreds, thousands, even millions, of users so economies of scale are achievable. For private information it becomes more difficult to maintain security of the information and reduce the possibility of serving information from one user's session to another user. Additional processing in the web server is required to maintain the privacy and security of the information.

Other mechanisms are used for unique, private and sensitive data to prevent caching the contents, data losses and security exposures. The dynamically generated private pages may include security credentials, sensitive private user and enterprise data. The browser cache expiration and no cache mechanisms are only adequate for sensitive yet infrequently used private web pages (files) used by casual users. The TCP/IP and browser architecture lacks transparent information data handling capabilities to ensure connection reliability, information protection at the user level and privacy of the information and processing while connected or disconnected. This transparent information data handling functionality exists on proprietary architectures including IBM's Systems Network Architecture (SNA) designed to manage the entire cycle without user intervention. Today's web architecture forces users to perform these recovery functions manually possibly corrupting the integrity of the information. Casual Internet users can usually tolerate the significant delays and failures inherent in requesting, generating and transporting these sensitive web pages. Frequent enterprise and loyal unique users of information and application services do not tolerate poor service. Ultimately, poor service may cause users to abandon the application or service on a temporary or permanent basis, which can impact business cycles such as sales or the online shopping cycle (i.e., preventing a purchase).

Various techniques have been developed to provide enhanced security, privacy, scalability, and performance improvements for the web architecture implementation 10 however, they require users to remain connected for the entire duration of an interactive session between the browser application and the web servers. The two primary techniques are (1) downloadable smart and mobile client applications with local databases replicated from the server (also called “smart clients”) and (2) shared secure web content, database or application cache replicas stored in the network centrally or geographically distributed with localized information and services. Client computer and network security has also been enhanced with multiple levels of network and PC firewalls and filtering to detect and stop malicious code and hackers from penetrating networks and computers. All of these methods designed to improve security reduce availability by creating connection delays, failures, auditing problems and degradation to the always-connected users of the web applications and information.

With the technique of smart and mobile client applications, some data is locally stored and replicated on the client machine 14 with application and business logic for editing and lookups. This is the typical technique used for multimedia and gaming applications on the web today—P2P (peer-to-peer between clients and servers) and/or the basic client/server models. These smart client and mobile client applications are dependent on the server at the centralized web computing resources 12 for all data operations. Requests often flow back and forth to the centralized servers on an as-needed basis. An application resident on the same computer as the browser application, called a client, makes requests over the communication network 16 to a server application using various protocols. There are variations of the smart client which require downloading of significant amounts of data to the client computer 14 for use by the application in connected or disconnected modes (offline). Various protocols which can be used to provide the application linking capabilities are Remote Procedure Calls (RPC) and Simple Object Access Protocol (SOAP, also known as Web Services). The smart, downloadable client applications may improve the reliability and performance of web applications while the user is connected to the network.

However, this technique presents significant maintenance and other problems for enterprise administrators responsible for maintaining multiple smart and mobile client applications and data on a single client machine. Furthermore, with centralization of business processes, compliance, security policies and regulations, it becomes increasingly difficult to maintain and manage business logic and data on many devices.

Furthermore, multiple client applications must be custom-developed for each web application to perform the application presentation layer duplicating the logic resident on the servers (e.g., form handling, connection management, logging, and data management). There is no reusable, general purpose smart or mobile client application capable of transparently supporting existing web applications on multiple platforms without significant custom coding and the use of duplicate management tools and infrastructure capable of creating new processing bottlenecks.

Also, many smart and mobile client applications, developed as downloadable browser resident applets, have failed in the market due to security restrictions in the browser and performance problems with browser application plug-in downloads. Most browser applications block plug-in loading because the same mechanism is used by malicious code to create problems on client computers. Current versions of smart clients partition the application logic (which makes remote calls to server logic) from the presentation logic (which offloads some of the web client processing). However, this technique requires multiple smart client applications with different behaviors for usability, logging, and reliability. Each individual client application must duplicate logging, exception handling, network communications, data management, and other common application functions with varying levels of sophistication.

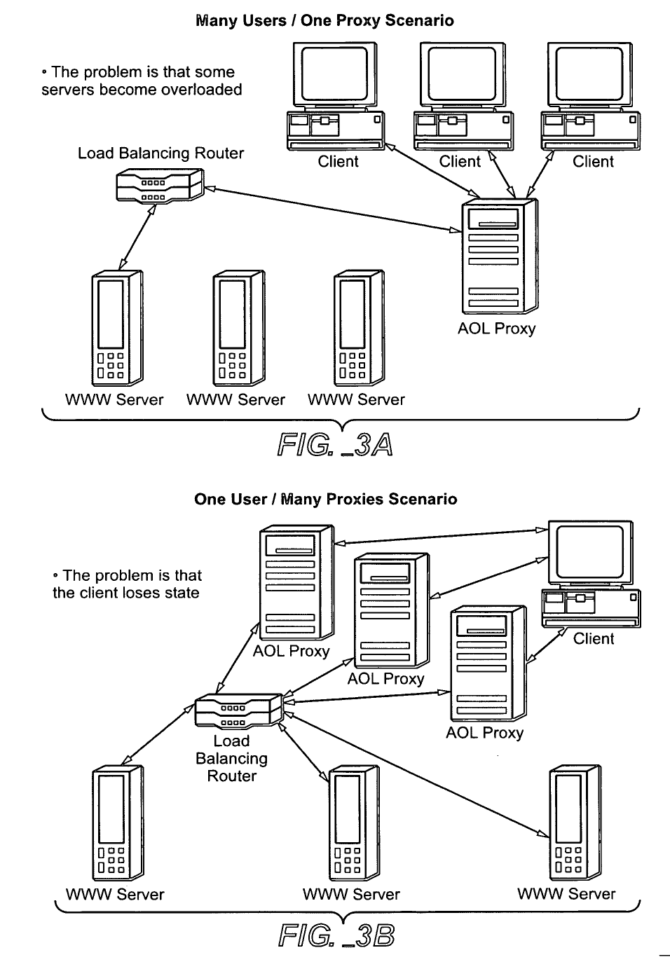

The client applications must also communicate with a remote server acting as a gateway to the main server application logic, which may be stored on a single web server. This creates single points of failure and bottlenecks for multiple smart and mobile client applications making requests directly to gateway servers or through a proxy, as can be seen in FIG. 3A. Referring to FIG. 3A, one web server may have server application logic which is a resource shared by multiple client computers. The web server is accessible through a proxy server and load balancing router. Each of the web server, proxy server, and load balancing router may be a single point of failure or bottleneck. For example, during peak periods of usage, the performance of the system degrades due to overload on one or more of the web server, proxy server, and load balancing router. This technique has limited scalability due to many complex factors causing performance degradation and failures. In addition, this technique typically requires a long running session between the browser application and the gateway computer in order to perform translation, compression, and other optimization services.

Further complicating the operation has been the addition of many layers of “security firewalls” causing delays and timeouts due to filtering and other overhead for every connection-oriented request. The firewalls are now at every layer of the architecture—from the client computer on which the browser application resides to the data centers where the data and application servers reside.

The second technique to improve the performance, privacy, usability and scalability of web applications is providing shared content and application caching mechanisms resident on servers or hardware appliances close to the browser client computers. This technique was developed to reduce the service latencies (i.e., server, network, etc.) between the browser client application on any number of remote computing devices, and the origin servers containing the data in the form of files, applications, or databases. These shared content and data/application caching techniques employ distributed physical servers with replicated content (also known as content distribution or application delivery networks). These distributed servers can be deployed by enterprises or provided through service companies with global web content and information networks.

Web and enterprise search engines for static files that employ centrally indexed and replicated content can also be used. This architecture ensures fast retrieval of public information pre-processed into small page chunks and may even allow for result caching in the browser if the information is not private. This architecture can be distributed to multiple geographic regions for faster access. This mechanism does not work for databases but only for static files. Databases have the additional complexity of thousands, if not millions, of combinations of dynamic query parameters for generation of dynamic pages from hundreds of thousands of web sites. These pages cannot be pre-indexed. Updating the indexes frequently can be a very resource intensive and costly process. These tools have evolved to support a desktop search and indexing capability for file content resident on the computer device not transparent web database information or interaction.

However, the distribution of data to servers outside of the data center, which is counter to centralizing data for ease of management and control, pose security access and other management problems. Database replication can be a complex and potentially, risky venture exposing more servers to multiple forms of attack for theft or other purposes. Database replication may require intrusive reconfiguration of a website architecture and network to support the data and server distribution and maintenance. Referring to FIG. 3B, content may be replicated on multiple proxy servers, each of which can be accessed by a client computer. Content may also be replicated on multiple web servers. In order to maintain the same content on different servers, high amounts of data and session synchronization are required. Replication overhead is high over a wide area network (WAN). Another problem that may arise is the client losing state. Furthermore, this database replication technique does not support global scale.

Solving performance and information availability problems for static web servers is costly and failure prone, but still possible while users are working on client computers 14 connected to the web applications over the network (e.g., wired or wireless network, LAN, or WAN). However, problem solving is nearly impossible for portable and mobile users with client computers 14 which are not connected to the network. Only while the client computer 14 is connected to the network can the content, applications, and databases be replicated and distributed to any point in the network close to the browser application requesting such content, applications, and databases. If the session is dropped or fails for any reason, the user of the client computer 14 must manually determine the cause of failure and either re-establish the session or establish the session from the beginning. This is adequate for public, shareable file content but difficult for private, personalized database information. Using this approach for personalized, localized application or database content is prohibitively expensive due to the cost of large scale data replication and maintenance over a wide area network (WAN) for each user's copy of data. Large scale metadata, data and content replication typically introduces data integrity issues. It also introduces security exposures and administrative complexity when attempting to control access to the distributed content and data. Large farms of costly servers and administrators in multiple geographic locations are required to place the content close to requesting browser applications (see also FIG. 3B). In addition, such web architectures may present single points of failure and/or bottlenecks in addition to increased risks of attack and theft (see also FIGS. 3A and 3B).

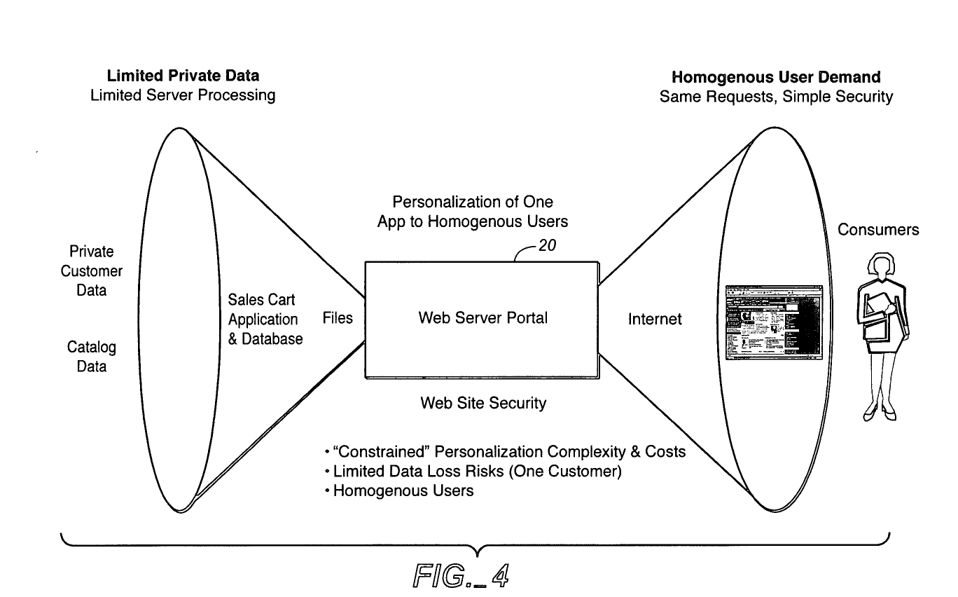

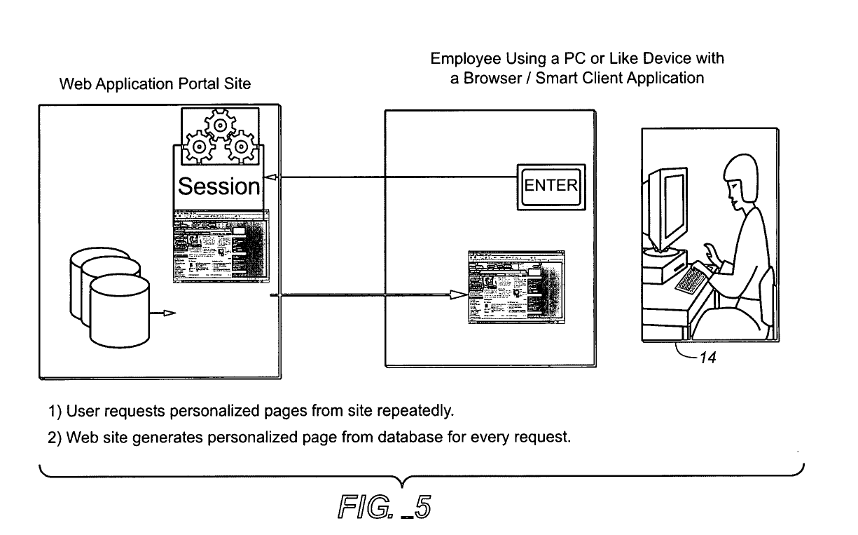

FIG. 4 illustrates customer personalization in a public Internet setting. By way of background, the first commercial use for the web architecture was public Internet-based electronic commerce and electronic documents. Users requiring database content from the public Internet are for the most part casual users, although there is a growing number of users who frequent the same sites and portals on a daily or hourly basis for fun or impulse buying. In the consumer and business domains, users typically spend more time and money with specific sites offering personalized database-driven services with various levels of incentives. However, the reality is that most of the content and information in web sites today are non-personalized static files cacheable and replicated at multiple points in the network, as previously discussed.

Referring to FIG. 4, an enterprise may develop, maintain, or contract for, web servers which provide content and applications (e.g., sales cart application and catalog data) through a web server portal 20. Only a limited amount of data is dynamically generated and personalized for users. The use of dynamically generated, personalized content is growing as commercial Internet sites evolve to provide personalized catalog, application, and information services in order to improve customer or consumer loyalty to the enterprise. Even then, the types of content demanded from users on the public Internet can be homogenous in many respects based on mass production techniques to serve the public. That is, users of the public Internet generally make the same requests for information and content from a particular website (e.g., catalog pages). In this way, there is limited personalization of content and data for individual users. Relatively simple security techniques can be used for this content and data. Occasionally, user specific data may be required (e.g., private customer data). But this private data is limited. The previously developed techniques of web caching, smart clients, and content/data replication are only suitable for public Internet users with these characteristics, and are not able scale up to support the growing amount of personalized, private web information and application services particularly on a global, yet localized, level.

Enterprises have adopted the web architecture implementation 10 of FIG. 1 believing there are economies of scale to be achieved through centralization of support and development resources, servers, databases, files (content), and security in the centralized web computing resources 12. The web architecture implementation 10 originally designed for the public Internet, however, does not meet the more demanding requirements of most enterprises in terms of cost, performance, security, scalability or usability, much less new requirements for mobility of the information for use while disconnected from the web and personalization of the application and information services to the needs of unique users.

To begin, the various techniques of the existing web architecture (e.g., synchronization and compression) do not scale because they form single points of failure and/or inline session processing bottlenecks while connected (see FIGS. 3A and 3B). These techniques require persistent sessions which require load balancing and security to be maintained with the web servers. In addition to users experiencing variable service delays, these techniques pose a security risk from hackers able to detect web sessions and trace back to the requesting user's client computer 14 or the web servers providing the services. These techniques cannot transparently support processing of the web application and information while a client computer 14 is disconnected from the network. The techniques of synchronization and compression (see FIG. 2) do not scale.

Furthermore, enterprise users and frequent users (who can be loyal and unique) behave differently, and thus have different needs than a casual user. Enterprise and frequent users require metadata, data and content that is more personalized compared to the casual public Internet user. With reference to FIG. 5, a web application portal 22 supporting an enterprise website is typically required to generate personalized private pages for every user request. The users (which can be employees, business partners, or loyal customers of the enterprise) may request personalized pages from the site repeatedly. This leads to overproduction that causes slow performance, audit problems, inefficiencies and high costs in addition to concerns about privacy, availability and security of the information.

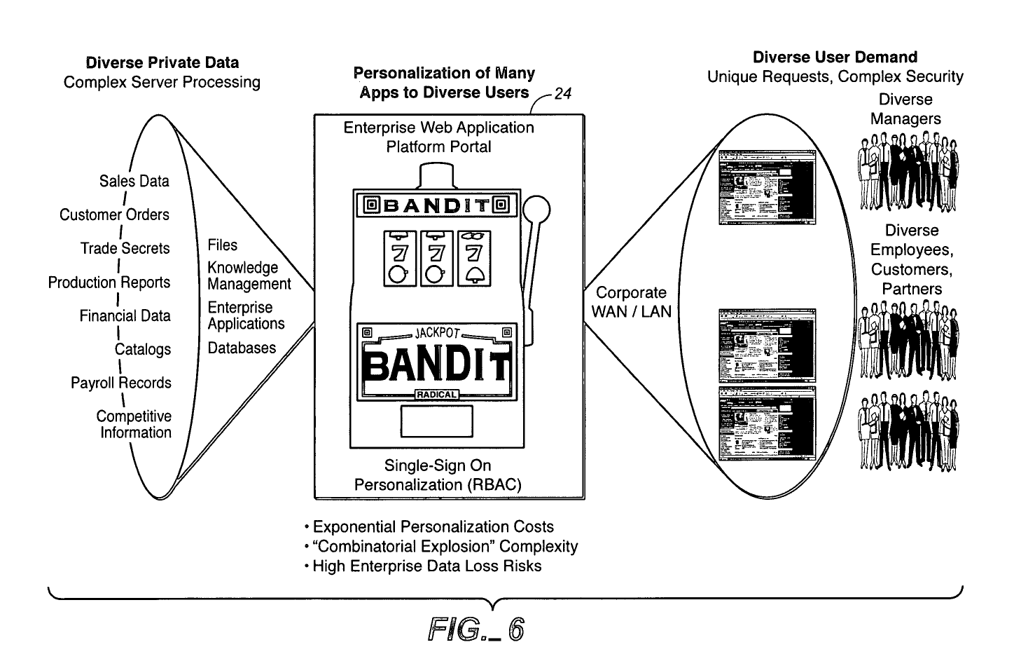

Referring to FIG. 6, the problem is exacerbated when an enterprise has many diverse employees and/or customers, each of which is requesting his or her own respective, personalized pages. This is also the case for commercial web sites desiring to implement an improved business information or shopping experience using personalized catalog and application services. FIG. 6 illustrates private enterprise-scale, demand-driven personalization. An enterprise may operate, maintain, contract, or otherwise provide an enterprise web application platform portal 24, which can support single-sign on personalization. The portal 24 allows the use or download of data and applications at an enterprise site, including, for example, sales data customer orders, trade secrets, production reports, financial data, catalogs, payroll records, competitive information, etc. Commercial and government enterprises are implementing customer loyalty programs where the public and premium web services can be highly personalized to the needs of unique users including, but not limited, to product selection and pricing. Problems in the context of private enterprise-scale, demand-driven personalization include exponential personalization costs, a “combinatorial explosion” in complexity, and high risks for loss of private enterprise data.

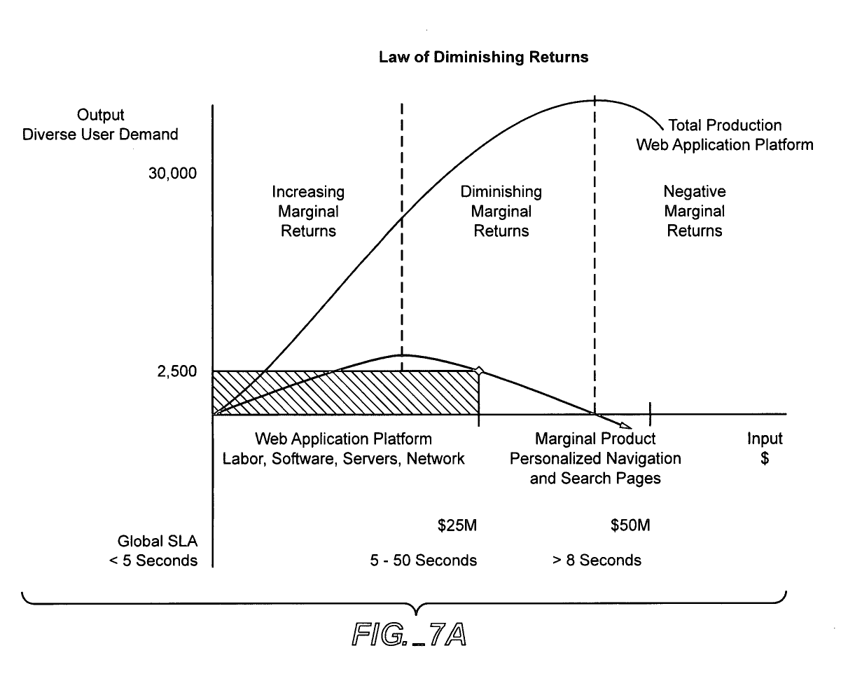

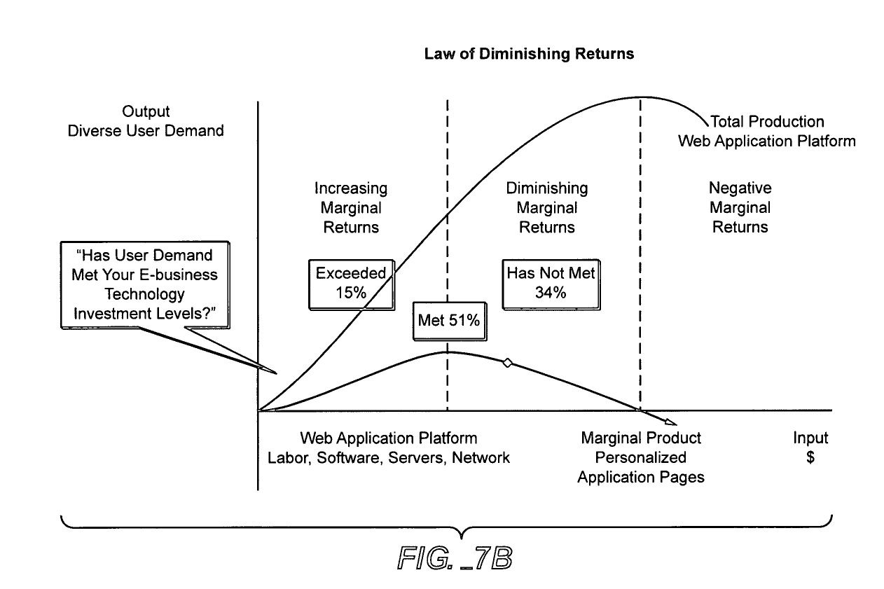

It is thus clear that previously developed techniques of web caching, smart clients, and content/data replication solutions do not meet the different behavior of unique users. Accordingly, an enterprise needs to spend substantially more time, money, and other resources in order to develop and operate a global personalized website suitable for its employees and unique users (including customers and business partners). Adding to the complexity is the need to tailor the information and services to the requirements of local markets, including language, customs, and business. Implementing the infrastructure to support more personalization and localization of services to the needs of unique users from multiple parts of the world is difficult without duplication of information, databases and other expensive computing resources. Further, the mobility of users introduces problems with location because users can access the web from multiple private and public locations with different IP addresses assigned to user computers. But the more that an enterprise spends, the smaller the marginal return that it derives, as can be seen in the diagrams of FIGS. 7A and 7B illustrating the diminishing returns for web application platforms in terms of output and user satisfaction. Indeed, it can be so expensive for an enterprise to adopt the current web architecture to its own needs that the enterprise simply cannot afford to use the web for any significant part of its business, particularly on a global scale.

Complicating matters for the enterprise is the fact that many parts of the world lack robust network connectivity and bandwidth that further inhibits the widespread deployment of the web architecture for enterprise, government and consumer use. Enterprises do not typically use public networks (e.g. Internet) for the management of their internal web applications due to security and service level quality issues. Increased bandwidth may solve some of the performance problems, but it still does not address the privacy and the need for location-aware user profiling information required for improvement of the unique user's shopping or other web application experience. In addition, enterprise users and loyal unique users (e.g., employees, business partners, and loyal customers) demand consistent response time behavior and reliable services to support their repetitive job, research, or shopping tasks, and they need it while connected and on the go with portable and mobile computers. The same is true for buyers and users visiting and using personalized catalog web sites of many types. Buyers will spend more time shopping online or offline if the experience is favorable while maintaining privacy.

According to various embodiments, the present invention provides distributed, location-aware systems and methods providing web application, metadata, data and content management services that overcomes the cost, scalability, performance, security, availability, mobility and usability problems inherent in previously developed browser client application and web server architecture implementations. The systems and methods, according to some embodiments of the present invention, can be used transparently for an enterprise web database application while connected or disconnected from the physical network. This can include operating while being in one or moving between multiple locations, including centralized portals with single user single sign-on authentication.

The systems and methods, according to various embodiments of the present invention, can also be used for many Internet applications using structured, interactive database catalogs of information delivered as premium or public information and application services used by the public or in private by authorized business, government and consumer users. Such interactive information catalogs can be, for example: publications of many types; personalized and public information portals; eLearning applications; online gaming; online auction catalogs; navigation maps for directions; online commercial shipping; card catalogs; course catalogs; yellow page and real estate listings; scientific databases for bioinformatics and R&D in many industries; email and instant messaging; historical email and plans/schedules of many types; online medicine; online gaming reference data; online research databases of many types including stock research; product and document catalogs; news and information portals; business to business product catalogs; entertainment guides including TV, radio and cable guides; auction catalogs; retail products; master data in enterprise applications of many types; and the like from consumer, business and government domains.

The systems and methods, according to various embodiments of the present invention, can have some universal applicability. This universal applicability eliminates the need to develop customized smart web clients or location-aware mobile clients capable of supporting rich, graphically-oriented interactions modeled after what existed in previously developed implementations for each application to support connected and disconnected modes of operations with location awareness. As such, these systems and methods, according to embodiments of the present invention, have broad applicability in many contexts, such as, for example, operation over the public Internet, any local area network (LAN), wide area network (WAN), virtual private network (VPN), wireless (WiFi) and (WiMax) network, satellite network, wireline network, voice network, data network, network storage management network, distributed or centralized servers, thin servers, blade PCs, personalized Internet access, Internet automobile access, Internet aircraft access, Internet train access, Internet applications on any stationary, mobile device or end user platforms, access appliances, kiosks, home appliances, small business applications, medium business applications, notebook and desktop consumer applications, personal computer, workstation, personal digital assistant (PDA), cellular telephone, plug-and-play appliance for auto-install and auto-uninstall of the software (e.g., USB virtual disk, PCMCIA card, compact flash or high-speed hypertransport plug and play devices), or other like network, server, access method, appliance, application, platform or device.

The systems and methods, according to various embodiments of the present invention, can provide for transparent administration for a web architecture implementation. This transparent administration component can, for example, transparently impersonate network or server resources. This component may support dynamic policy-based registration and reconfiguration of virtual server resources and preferences. The transparent administration component may run or implement various algorithms. Self-configuration transparent algorithms may provide or support policy-driven auto-configuration from network, local, or default behaviors; proxy server impersonation with centralized policy control; transparent session and security inheritance; automatic user detection and private storage setup, cleanup and optimization; automated browser/network configuration synchronization and key management; and dynamic web client storage management. Self-tuning transparent algorithms may provide or support automatic pre-fetching from local or network sources; automated private storage creation, encryption, compaction, data compression, metadata and logs; automated storage index optimization; high-speed in-memory request pattern matching, routing, fetching and assembly; persistent network connection management and optimization; recoverable downloads; and network resource controllers (bandwidth, multi-protocols). Furthermore, self-healing transparent algorithms may provide or support transparent recovery from failures, reliable download management and transparent session and network protocol management while capturing accurate, pre-aggregated user-level metrics.

The adaptive self-tuning, self-configuring and self-healing web architecture implementation delivers tremendous economic value and information process cycle time improvements on a per-user basis by safely avoiding network resource utilization and by exploiting low cost computing and storage resources on user devices where the browser and/or smart web client application resides. Any suitable user device can be converted to support a lightweight virtual server application (according to an embodiment of the present invention) that manages unique web page requests and stores frequently accessed pages and search results (stored queries) in a local secure virtual storage. In one embodiment, no additional hardware assets are required to achieve immediate benefits and improvement in terms of performance and service. In another embodiment, software can be implemented in an application specific integrated circuit (ASIC) or other micro-hardware including system-on-a-chip and package-on-a-chip hardware.

In the remainder of this description, systems and methods, according to various embodiment of the present invention, are described primarily with regard to how they meet the specialized needs and requirements of enterprises and their respective internal and external users. It should be understood that the invention is not limited to only the context of an enterprise application but also applies to a multitude of Internet applications for consumers, business, and government users.

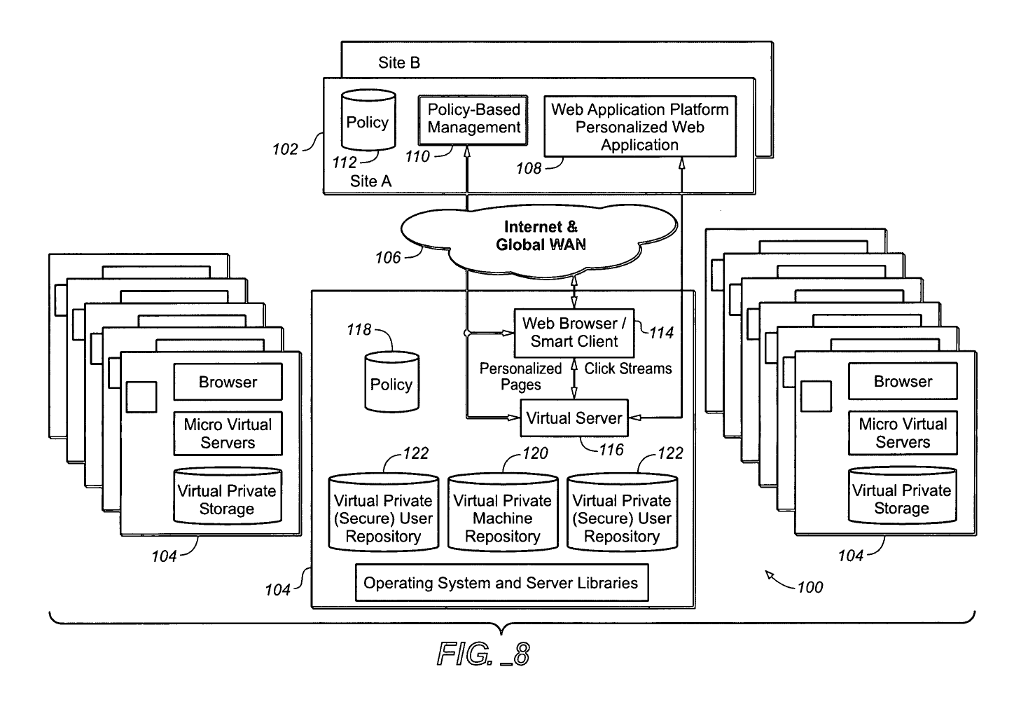

FIG. 8 is a diagram of one web architecture implementation 100, according to an embodiment of the present invention. Portions of web architecture implementation 100 may be operated and/or maintained by an enterprise for providing application, metadata, data and content management services (along with corresponding methods). The web architecture implementation 100 can be distributed, transparent, and location-aware. As depicted, web architecture implementation 100 includes centralized web computing resources 102 and a network of client computers 104 connected by a communication network 106.

The centralized web computing resources 102 for the enterprise may be maintained on servers (e.g., web servers, application servers, or other appliances) operating at one or more sites (e.g., Site A and Site B). As shown, the centralized web computing resources 102 may include a web application platform 108, a policy-based management application 110, and a policy database 112. The web application platform 108 functions to provide or support personalized web applications for users, which can include, for example, web executables, directory, metadata, data, and content. Policy-based management application 110 functions to provide or support policies or rules for maintaining, updating, managing, or otherwise handling applications or information in web architecture implementation 100. The policy-based management application 110 manages the web executables, directory, metadata, data and content on a web application platform 108. The policy-based management application 110 and web application platform 108 may function to take various actions based on the policies of the enterprise. This may include, for example, installation of a virtual server application 116 on enterprise client computers 114, the delivery of specific executables, directory, metadata, data and content to each enterprise computer either automatically or based on requests by users (e.g., demand-driven data replenishment policies), and the like. Policy database 112 stores the policies which are executed by policy-based management component 110.

Centralized web computing resources 102 may also include one or more web servers which maintain websites. Web servers provide or support information and applications for one or more static or dynamic web pages for providing information. Each website or web page can be identified by a respective URL (Uniform Resource Locator), and may be supported by documents formatted in any suitable language, such as, for example, hypertext markup language (HTML), extended markup language (XML), or standard generalized markup language (SGML).

Communication network 106 can include any portion of one or more suitable networks for communicating information or data. For example, such a network can be the Internet or a global wide area network (WAN) over which information can be exchanged according to Transmission Control Protocol/Internet Protocol (TCP/IP), Internetwork Packet eXchange/Sequence Packet eXchange (IPX/SPX), AppleTalk, or other suitable protocol. Communication network 106 may also include some portions of a telecommunications network which supports telephony and voice services, including plain old telephone service (POTS), digital services, cellular service, wireless service, pager service, etc. The telecommunications network allows communication via a telecommunications line, such as an analog telephone line, digital subscriber line (DSL), a digital T1 line, a digital T3 line, or an OC3 telephony feed. The telecommunications network may include a public switched telephone network (PSTN) and/or a private system (e.g., cellular system) implemented with a number of switches, wire lines, fiber-optic cable, land-based transmission towers, spaced-based satellite transponders, etc. In one embodiment, the telecommunications network may include any other suitable communication system, such as a specialized mobile radio (SMR) system. As such, the telecommunications network may support a variety of communications, including, but not limited to, local telephony, toll (i.e., long distance), and wireless (e.g., analog cellular system, digital cellular system, Personal Communication System (PCS), Cellular Digital Packet Data (CDPD), ARDIS, RAM Mobile Data, Metricom Ricochet, paging, and Enhanced Specialized Mobile Radio (ESMR)). The telecommunications network may utilize various calling protocols (e.g., Inband, Integrated Services Digital Network (ISDN) and Signaling System No. 7 (SS7) call protocols) and other suitable protocols (e.g., Enhanced Throughput Cellular (ETC), Enhanced Cellular Control (EC²), MNP10, MNP10-EC, Throughput Accelerator (TXCEL), Mobile Data Link Protocol, etc.). Transmissions over the telecommunications network may be analog or digital. Transmissions may also include one or more infrared links (e.g., IRDA).

Each client computer 104 can be a workstation, personal computer (PC), personal digital assistant (PDA), server machine, PCMCIA Card, or other suitable hardware device running suitable software. As shown, an exemplary client computer 104 may comprise a browser or smart web client application 114, a virtual server application 116, and various databases or repositories, including a policy database 118, a virtual private machine repository 120, and one or more virtual private (secure) user repositories 118. In one embodiment, a separate virtual private user repository 118 may be provided for each user who works on the client computer 104, thus maintaining security and privacy between users.

The web browser or smart web client application 114 may act as a general-purpose thin client document viewing application used to navigate and browse through the World Wide Web network of web servers to find, retrieve and view file-based documents addressed with a unique URL. Any of a variety of web browsers are available, such as NETSCAPE NAVIGATOR from Netscape Communications Corp., INTERNET EXPLORER from Microsoft Corporation, and others that allow convenient access and navigation of the Internet using a suitable protocol, such as, for example, HyperText Transfer Protocol (HTTP) or File Transfer Protocol (FTP).

In one embodiment, a respective virtual server application 116 is installed in each of a number of user devices (client computers 104) for an enterprise. Each virtual server application 116 can be implemented in hardware or software, and may incorporate or be in communication with the virtual private repositories 120 and 122 in a trusted privacy zone. The virtual private repositories 120 and 122 can provide secure, self-protected private user data storage and application management. Private data storage can be dynamically allocated based on security credentials and managed using policies and security keys of the user currently logged-in to the client computer 104. Each virtual private user repository 122 can be secure and may be user specific. The virtual server application 116 may assign or create a virtual private user repository for each enterprise user who uses the respective client computer 104. The virtual private user repository 122 may manage, store or maintain executables, directory, metadata, data and content that are personalized for the respective user. The virtual private machine repository 120 may store other executables, directory, metadata, data and content, for example, that is specific for the particular client computer 104 on which it resides. The virtual server application 116 may provide optimization for managing the virtual repositories or storage of varying complexity to satisfy simple or multi-dimensional queries (unique user requests). Storage in the virtual private repositories 120 and 122 can be at the application user space level (i.e., executable logic and data running under the user's authorization level).

The virtual server application 116, virtual private machine repository 120, and virtual private user repository 122—which may reside behind a firewall of the client computer 104—function to maintain or store frequently accessed data and executable content close to the unique user that makes specific requests on the client computer 104. In particular, a user's web client logic and information can be dynamically reconstructed on the virtual server application 116 and associated repositories in the client computer 104 through which that user interacts with the web architecture implementation 100. User requests to the user's web client logic and information can be fulfilled by the virtual server application 116, virtual private machine repository 120, and virtual private user repository 122 at the client computer 104. This provides for rapid execution and assembly of dynamic web pages in response to user requests. In particular, with the provision of the virtual server application 116, virtual private machine repository 120, and virtual private user repository 122 on the client computer 104, the web architecture implementation 100 avoids the round trip delays inherent in the previous web architecture implementation where the personalized client logic is resident only on the web servers. Furthermore, a user's requests are processed behind the device firewall while connected or disconnected.

This web architecture implementation 100 provides a distributed, virtual web application management system that overcomes the cost, scalability, performance, security and usability problems inherent in the previously developed browser, smart web client application and web server architecture implementations. The web architecture implementation 100, according to an embodiment of the present invention, works at least in part on the principle of locality of reference for each user.

Portions of the web architecture implementation 100—e.g., performance and security, administration and the existing web application/network infrastructure—an be designed to be transparent to users. The web architecture implementation 100 inherits the security of each user by running as a user service in the user processing space, thereby automatically protecting the local storage and ensuring that each user is accessing authorized web pages. All of this can be accomplished with little or no administration required on the client computer 104 where the browser and/or smart web client application is resident. For example, server impersonation techniques using policy-based management and auto-configuration techniques allows existing administration tools to be used for the remote configuration and administration of the virtual server application 116, virtual private machine repository 120, and virtual private user repository 122, thereby significantly reducing costs for administrator training and deployment. In one embodiment, the various levels or forms of transparency in the web architecture implementation 100 may be as follows:

Infrastructure—The software virtualizes web clients without requiring changes to existing enterprise applications, sessions, security or networks. The integrated architecture is policy-driven and can include a transparent proxy with private content and storage management for virtual web clients. It dynamically offloads configurable personalized web client logic and content to remote devices (e.g., client computers 104) without changes. It does not require creation and development of distributed custom smart client applications.

Browser and/or smart web client application (presentation layer)—The software is transparent to the rendered application on the browser and cookies (session security).

Browser and/or smart web client application—The software inherits the security credentials used by the browser application and provides extensions in the areas of fault recovery, performance, security and compliance audit tracking for information.

User—Does not require user intervention or configuration to support dynamic web clients using any type of executables, directory, metadata, data and content.

Administrator—Does not require constant tuning or configuration of individual virtual server applications. Software is designed to self-tune and self-configure.

Device Platform—Software is designed to run on single-, dual-, and multi-core uni- and multiprocessing personal computers (PCs), workstations, gaming devices, cellular phones, plug-and-play appliances (such as virtual disks), personal digital assistants (PDAs), servers, kiosks, terminals, or other like devices.

Also, with this web architecture implementation 100, updates (refreshes) to or uploads from the local storage (virtual private repositories 120 and 122) at the client computers 104 can be scheduled at off-peak processing periods when there is minimal impact to the browser and/or smart web clients applications 114, the servers at centralized web computing resources 102, and network infrastructure. This can be accomplished, for example, using policies stored in the policy databases 118 and/or 112.

The web architecture implementation 100, according to embodiments of the present invention, reduce infrastructure loads (e.g., processing and transmission usage) for enterprises and increases operational efficiency while improving the privacy and security for each user and providing complex interactive database applications. Processing is moved from the web and application servers at the centralized web computing resources 102 to the more idle hardware assets of enterprise user devices (i.e., client computers 104). Indeed, in some situations, 60-80% of an enterprise user's requests or other web activity can be performed at the user's client computer 104. Because less communication occurs between the users' client computers 104 and the centralized web computing resources 102, load on the transmission network can be substantially reduced (e.g., by up to 60%). As such, the expense of deploying, operating, and administering hardware throughout the architecture implementation 100 is dramatically reduced relative to previously developed architecture implementations. The web architecture implementation 100 supports centralization of data and databases while distributing the user loads for information processing (which is mostly read-only information). The read-only information does not require expensive storage management because the data is centralized and regularly backed up.

With the web architecture implementation 100, an enterprise can manage the performance and storage policies for each distributed virtual server application 116 co-resident with a browser and/or smart web client application 114 on a client computer 104. Requests from the browser and/or smart web client application 114 are proxied to the virtual server application 116 for processing. The virtual server application 116, which is transparent to the user, evaluates each request and routes appropriately to either the origin server (at the centralized web computing resources 102) or to the local virtual content and storage servers (e.g., virtual private repositories 120 and 122). Locally stored content in virtual private storage can be used to satisfy repetitive requests at consistent response time behavior and sub-second response times in many cases.

A physical loss of the distributed virtual executables, directory, metadata, data and content storage on any device (e.g., due to disk failure) is not catastrophic because the information and content is centrally stored at the centralized web computing resources 102 and can be recovered based on enterprise data management policies. The software (e.g., for the virtual server application 116) can be dynamically reinstalled providing automatic rebuilding of the private repositories based on user demand (unique personalized requests from the user).

The web architecture implementation 100 includes central policy-based management using server impersonation techniques. The virtual server application 116 adds reliability to the traditionally unreliable web architecture implementation. Robust activity logging for performance, usability, security, compliance and accounting purposes may be provided, with aggregated log-management built-in. Many web application errors can be recovered and failures are logged for further analysis (component level failure analysis). Comprehensive logging at the machine and user level provides new insights into the user experience for not only performance but quality of service. The logs are designed to be compatible with existing centralized server logs for quick reporting and analysis integration. These various components support advanced integrated user instrumentation and activity accounting. This provides a system administrator with failure metrics which enhances recovery. Furthermore, it makes the web architecture implementation 100 more useable and valuable.

The virtual server application 116 can support any Internet web page executables, directory, data or content, either static or dynamically generated, on thin and/or smart client applications. The content can include data of any type, metadata (e.g., web page with page links) and executable content (e.g., scripts and embeddable application components including advanced multi-dimensional graphics). The virtual server application 116 can perform complex pattern matching of requests to identify unique executables, directory, metadata, data, and content requests for fetching, assembly and serving to the browser and/or smart web client application 114 resident on the respective client computers 104 (user devices). In one embodiment, auto-configuration of the rules can be implemented externally to the virtual server application 116. In another embodiment, the rules can be embedded in the virtual server application 116. Hashing routines may be used to index and retrieve executables, directory, metadata, data, and content quickly at up to sub-second speeds using the layered memory manager. Optimization algorithms continuously compact indices and storage in the virtual repositories while removing stale, outdated data (i.e., data that has expired). An expiration policy can be set centrally to control or manage the freshness of information, application logic and content (i.e., by replacing stale information on the fly).

In one embodiment, the virtual server applications 116 can be deployed from one or more network distribution points using silent, unattended techniques (requiring little or no user intervention) to install and configure on respective enterprise client computers 104 in the background, for example, upon user login to the computers. Multiple enterprise policy-based administration tools can be used to support an unattended deployment due to the server impersonation techniques used by the software. The policies for such tools can be maintained at least or in part on the enterprise user client computers 104. The software can also be installed and configured using self-service techniques commonly used for installation of standard applications on client and server computers or new methods for out-of-band configuration of hardware-loaded software services.

The virtual server applications 116 on the enterprise user client computers 104 may interact with the respective web browsers, smart web client applications 114 and with centralized web computing resources 102 of the enterprise, via a suitable network such as a local area network (LAN), wide area network (WAN), virtual private network (VPN), wireless (WiFi) network and/or satellite network.

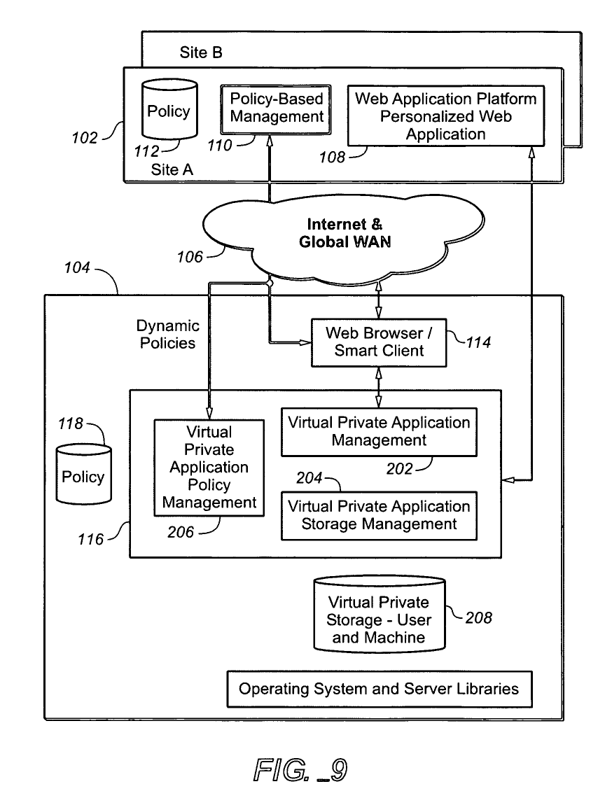

FIG. 9 is a diagram of another web architecture implementation 200, according to an embodiment of the present invention. Web architecture implementation 200 of FIG. 9 is similar to web architecture implementation 100 of FIG. 8 and, as shown, includes centralized web computing resources 102 and a client computer 104 connected by a communication network 106.

In web architecture implementation 200, virtual server application 116 in one embodiment can include components for virtual private application management 202, virtual private (self-protected) application storage management 204, and virtual private application policy management 206. These components 202, 204, and 206 may comprise software routines or applications for performing specific functions. The virtual private application management component 202 may, for example, provide or support security, routing, personalization and networking for the virtual server application 116. The virtual private application storage management component 204 may, for example, compress, encrypt, index, upload, download, filter and otherwise manage or process the metadata, data and content handled by the virtual server 116. The virtual private application policy management component 206 may, for example, support configuration of the virtual server application 116 and the associated repositories (shown as virtual private storage database 208). Virtual private storage database 208 may store application executables and content for automatic application protection.

FIG. 10 is a diagram for use of web architecture implementation 300 for virtual private personalized application, according to an embodiment of the present invention. Web architecture implementation 300 of FIG. 10 is similar to web architecture implementation 100 of FIG. 8 and, as shown, includes centralized web computing resources 102 and a client computer 104 connected by a communication network 106. The web architecture implementation 300, which provides or supports virtual private personalized applications (VPPA), can be the environment for a user workplace for virtual personalized web database applications. For this, web application platform 302 functions to provide or support private, personalized web applications for users, which can include, for example, web executables, directory, metadata, data, and content. These virtual private applications (which are executable logic) can be downloaded along with dynamic and static private pages to virtual server application 116 using the browser and/or smart web client application 114. The virtual private applications can be managed by the virtual server application 116 for response to subsequent requests by the browser and/or smart web client application 114 for page views. The server side at the centralized web computing resources 102 is only used to refresh virtual web clients (content and executable logic) based on policies (stored in policy databases 112 and 118). The web architecture implementation 300 controls the complexity of delivering many applications, metadata, data and content to many diverse users from anywhere on the Internet transparently with complete location and unique user awareness, thus achieving enterprise-scale web application and information personalization.

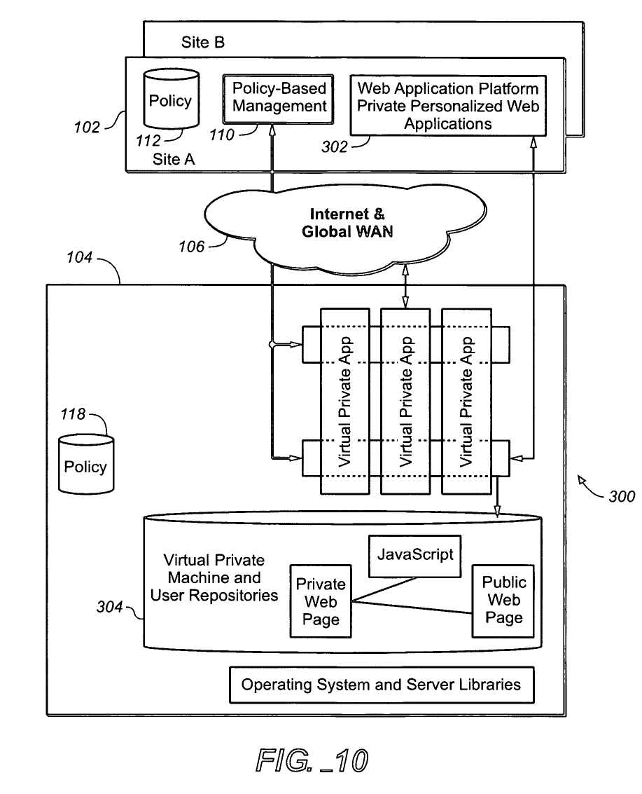

FIG. 11 illustrates use of a virtual server application 116 in a typical enterprise scenario, according to an embodiment of the present invention. In this scenario, a user can be an employee using a client computer 104 (which can be a personal computer (PC) or other device) having a browser or smart client application 116 to access a web application portal site 400 for the enterprise.

The virtual server application 116 can be implemented as a software application distinct from a typical web browser and/or smart web client application 114 residing in the application layer. To the enterprise web browser and/or smart web client application 114 resident on the client computer 104, the virtual server application 116 appears or functions as a server which stores and delivers private metadata, data and content of any type, format or executable application logic in response to requests by the enterprise user via a browser and/or smart web client application 116. The virtual server application 116 can operate in a trusted privacy zone on the user's client computer 114. The trusted privacy zone, which is protected by the client computer's centrally configured and controlled firewall, has the security level equivalent to the data center resources.

The web application portal site 400 provides access to the executables, directory, data, or content that may be stored in multiple distributed servers maintained, operated, managed, or otherwise controlled by the enterprise. Some of the executables, directory, metadata, data, and content can be unchanging or static (e.g., name of the enterprise, business locations, etc.), while other of the executables, directory, metadata, data and content can be dynamic (e.g., monthly sales figures, accounts receivable, production levels, etc.).

The enterprise user at the client computer 104 may make requests for particular private executables, directory, data or content. This private content can be personalized for the enterprise user in many respects, for example, based on the privilege level of the unique user (e.g., employee, loyal or casual customer, partner, manager, vice-president, president, CEO, CFO, etc.), the user's region of operation (e.g., California, United States, North America, Asia, etc.), the user's responsibilities (e.g., billing, marketing, sales, production, buyer, shopper, etc.) and the like. In one embodiment, an application may be optionally installed at one or more servers of the enterprise website for communication and coordination with the virtual server application 116 at the enterprise user's client computer 104.

In operation, the executables, directory, metadata, data, and content may be retrieved from the network servers of the enterprise's web application portal site 400 when the user first requests such executables, directory, data, or content from the website of the enterprise using the browser and/or smart web client application 114 of the user's client computer 104. When the executables, directory, data or content is received at the client computer 104, the virtual server application 116 stores and indexes it in its layered memory manager. The next time the user makes a request for the same executables, directory, metadata, data, and content, it will be provided from the virtual server application 116 rather than the enterprise website.

Requests can be of varying complexity including multi-dimensional, relational and other structured queries. In some embodiments, executables, directory, data or content that is relevant to a particular user may be automatically pre-fetched, pre-scheduled, and downloaded to the virtual server application in the user's client computer 104, rather than or in addition to being delivered in response to the user's requests. A system with the virtual server application 116 may automatically secure and control copies of private enterprise data for every user logging into a particular client computer 104. No administration is required to provide automatic protection of the private enterprise data using encryption and other security methods. Centralized control is provided using auto-configuration policy rules stored centrally or distributed within the enterprise, for example, at the centralized web computing resources 102.

Since the virtual server application 116 resides on client computer 104 of the enterprise user, the executables, directory, metadata, data, and content stored therein is delivered more rapidly and efficiently using virtual resources on the computer in a trusted privacy zone, which in some cases is safely behind the PC firewall (e.g., sub-second response times) than would be the case if the executables, directory, metadata, data, and content were to be sent from one or more enterprise websites each time the user makes a request for a specific navigation, graphic, or other page. As such, the virtual server application 116 reduces repetitive web application navigation and search times, thus improving the information processing cycle for each user (regardless of whether the process is shopping, analyzing enterprise sales, or analyzing scientific data). This can significantly increase LAN/WAN bandwidth capacity, while simultaneously appearing to the user as a huge boost in application performance and productivity while connected or disconnected from the network. The virtual server application 116 fulfills unpredictable demand for enterprise data at consistent service levels limited by the processing capabilities of the enterprise user's client computer 104.

As stated previously, enterprise and loyal unique users have different behaviors than a casual user. Enterprise and loyal unique users work with a finite set of complex, working web pages tailored to their specific job tasks or goals—i.e., consumers shopping for a specific item while comparing vendors, products, and prices, or researchers working on a project. These specific web pages are uniquely generated based on each user's security and preference profiles defined for their information access requirements (job or role levels) on a demand-driven basis as users drive one or more information processing cycles requesting a unique set of information on a goal-oriented basis. This cyclic information processing behavior—e.g., comparison shopping, analysis of business information, researching information as part of a project, etc.—requires a web architecture implementation that can provide adequate security for dynamically generated, uniquely personalized, executable web pages containing graphics, text, directory, and application logic that are used for repetitive web site navigation, exploration, and searching within an enterprise web application database. These unique web pages cannot be cached efficiently in a centrally-located, shared cache because they are dynamically generated on a per-request basis, which achieves no economies for the provider of the web database application or service. This private information should be processed behind the user's firewalls, while connected or disconnected from the network, to ensure privacy and optimum performance.

Users of interactive database applications could also use large sets of data generated by various web database application systems. These dynamically-generated, ad-hoc, interactive database information pages can vary in size from one to hundreds or thousands of web pages. These interactive page views are dynamically-generated based on the unique request parameters of a user based on his or her unique requests. For example, a sales representative in Egypt would only be interested in generating a request for information on customers based in Egypt, or even more specifically, to his/her city or area of responsibility. Because these same report pages would not be generated for any other user, it would not be useful to cache the content centrally, which would require round trips to the server for refreshing when the user requests the same information again. However, this same user typically requests the same report more than once during a reporting period (e.g., several times a day or many times in a week) while working on a goal or project, yet the origin database may only change at the end of the day or once a week. Therefore, the information would be repeatedly generated by the enterprise's central web site and transported over the network due to the lack of local information management capability close to the requesting user consuming many resources and creating security risks.

Centrally-located shared caches have been adapted, in an attempt to achieve economies, by breaking down web pages into fragments and caching the compressed fragments. However, this constant evaluation of web pages down to a fragment level does not scale on web servers and appliances that compare each web page fragment to incoming requests for pages and page views. Tremendous resources are required to evaluate each page request and perform detailed comparisons (for example, using previously developed file synchronization techniques). Under heavy loads this architecture collapses and degrades just like a web server—i.e., single points of failure due to load stress/congestion. These centralized web architecture implementations fail to deliver consistent, reliable service on a global scale due to a dependence on the network for delivery and server processing overhead. The dependence on the network also requires a long running session for each user. Long running sessions are difficult to maintain and may introduce security and load balancing challenges.

A large gap exists in previously developed web architectures for the accurate collection of location-aware unique user metrics, particularly with the lockdown of security that reduces the use of cookies and other site-level tracking methods used to identify the unique access and hit patterns of users. Most users are reluctant to use cookies, which is the typical technique used to identify unique users, unless there is a compelling reason. Without this unique user identification, it is difficult to know who the specific user is on a particular client machine is. It is common to have multiple users share a client machine, and the address of computers is constantly changing as some users move from location to location. The lack of location-awareness to identify a unique user to a web site makes it difficult to establish an interactive, personalized session between the site and the unique user. Processing the detailed web logs to construct a unique user identification profile is also very difficult, particularly as web sites scale up to many systems creating session logs on each server and appliance. Furthermore, it is difficult to obtain accurate service level metrics at a unique user level, particularly in regards to multiple locations. Many users are using portable and mobile devices which may be accessing the web database applications from multiple locations where the addresses are dynamically generated for the machines upon connection to the network (e.g., home, enterprise, and public wired and wireless networks). Personalizing applications to the unique user operating in multiple locations is a significant challenge with today's technology. Accurately capturing service metrics across the wide variety of local networks used to access the applications is even more difficult.

The system, architectures, and methods according to various embodiments of the present invention substantially reduce or eliminate many of these problems for an enterprise whether the Internet application is highly personalized and used for internal or external unique users. Some embodiments transparently integrate critical functions missing in the current TCP/IP application layer to provide an information virtualization capability designed with microchip techniques. Many complex, interactive Internet database applications can be supported transparently by incorporating general-purpose algorithms and logic to manage the unique patterns by types of applications, such as shopping applications or business intelligence on the local computer rather than hard-coding the logic.

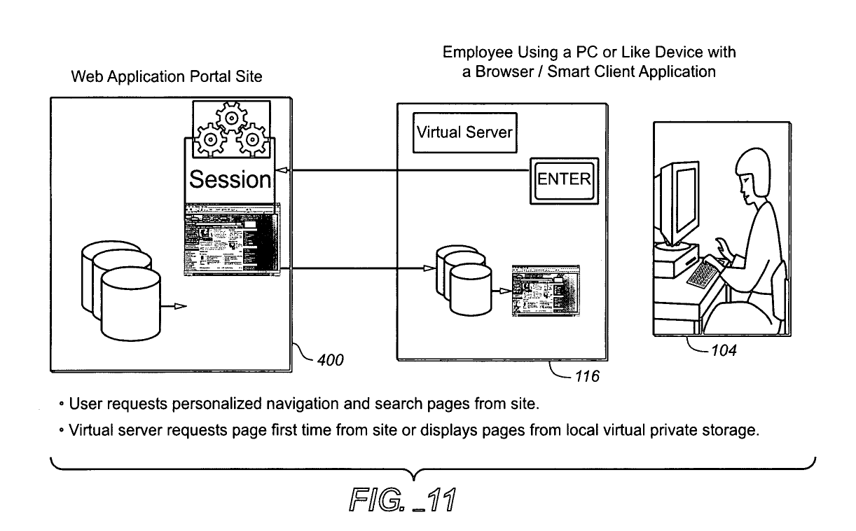

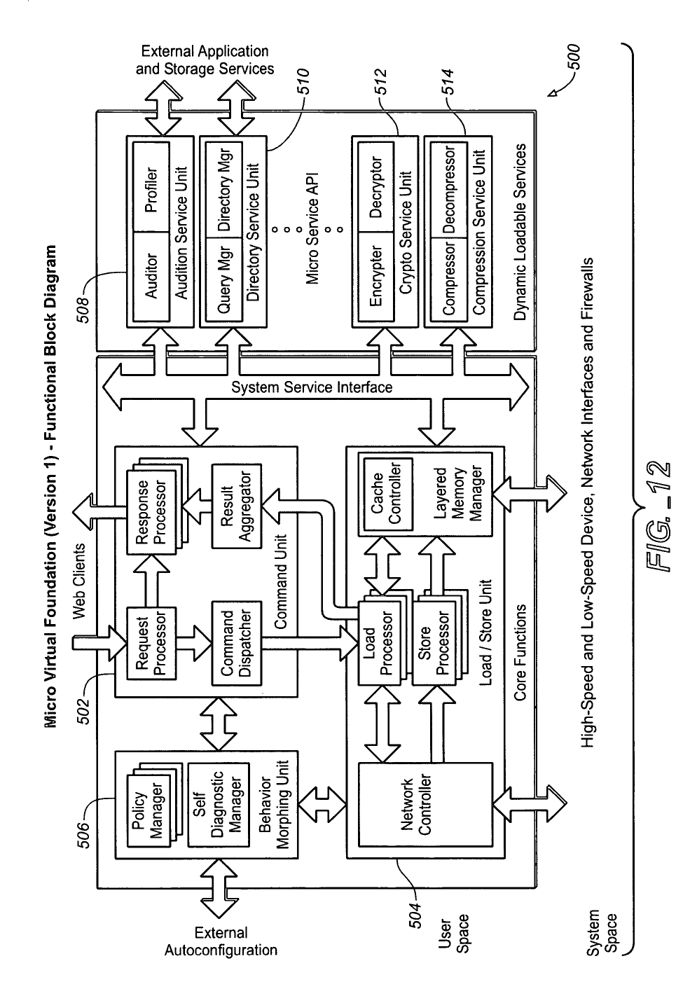

FIG. 12 is a block diagram of a microchip implementation 500 for the virtual server application 116, according to embodiments of the present invention. FIG. 12 illustrates the system diagram of the integrated superscalar, superpipelined, superthreaded functions of the virtual server application 116, in some embodiments of the invention.

In one embodiment, the microchip implementation 500 for the virtual server application 116 can operate with functions having CPU and storage affinity to one or more CPU cores, thus duplicating the scalability features of large scale compute clusters; the remaining CPU cores can be used to time-slice various web client applications for creating a self-contained load-balanced virtual Internet system employing the same optimization techniques as used in data centers. In another embodiment, the microchip implementation 500 can be a system on a monolithic semiconductor die (commonly referred to as a “chip”), package on a chip, application specific integrated circuit (ASIC), flash memory of various types and loadable from external micro USB or other bus attachable to client computer 104. Microchip implementation 500 may be installed into a personal computer (PC), workstation, gaming device, personal digital assistant (PDA), cellular telephone, plug-and-play appliance for auto-install and auto-uninstall of the software (e.g., USB virtual disk, hypertransport device or PCMCIA card), or other like device of an enterprise, consumer or government user.

Also, the microchip implementation 500 for the virtual server application 116 can provide a secure environment for the executables, directory, data, and content in a trusted privacy zone on the user's client computer 104. The microchip implementation 500 for the virtual server application 116 may be configured to distinguish users, so that any user which works on a given client computer 104 is only provided with executables, directory, data, or content that is relevant to him/her from the encrypted private virtual storage based on the unique key of the computer user's login session. The microchip implementation 500 for the virtual server application 116 may deliver enterprise-class, virtual personalized navigation, graphics, and searches in response to each unique request. Each request is privately processed in the user space in the trusted privacy zone within the PC's login session securely behind the PC's firewall.

As shown in FIG. 12, the microchip implementation 500 for the virtual server application 116 may comprise components for performing core functions and components which may be dynamically loadable services. The components for performing core functions may include a command unit 502, a load/store unit 504, and a behavior morphing unit 506. The components which are dynamic loadable services may include an audition service unit 508, a directory service unit 510, a cryptographic service unit 512, a compression/decompression service unit 514, and the like. Both the core and the dynamic loadable services can be superscalar, superpipelined, and superthreaded.

In the core, the behavior morphing unit 506 may implement adaptive behavior learning techniques for self-tuning personalized applications in the microchip implementation 500 for the virtual server application 114. This functionality is also referred to as autonomic computing capabilities. Autonomic computing capabilities provide dynamic policy-based, auto-configuration of the virtual server application's behavior personalized to a user level based on policies for locations and sites.

The behavior morphing unit 506 functions to interface with any standard external autoconfiguration capability designed to support software and hardware systems. The external autoconfiguration capability can be used to reconfigure the behavior of the virtual server application 116 based on preferences and policies refreshable at intervals defined by enterprises or users. In one embodiment, there can be centralized, autoconfigurable policy-based management and deployment of micro-sized packages of executables, directory, metadata, data, and content in a “stealth mode” using server impersonation techniques. This allows for non-intrusive, transparent integration with web application platforms, data, networks,. and security, providing for seamless coexistence on distributed assets. This can significantly reduce labor costs and end user training associated with deployment.

A policy manager in the behavior morphing unit 506 obtains policies and preferences from a combination of system registry settings centrally configured by group policy tools. These group policy tools can be associated with directory services pointing the user's browser to an autoconfiguration script used to personalize settings and redirect requests to the microchip implementation 500 for the virtual server application 116. In one embodiment, the same script used to autoconfigure the browser application is used to provide the policy manager with policies and preferences for the command unit 502, the load/store unit 504, the directory services unit 510, and compression/decompression service unit 514. The policy manager can be used to personalize the software to the needs of an individual user. That is, the policies and preferences obtained by the policy manager in the behavior morphing unit 506 control information processing, bandwidth allocation, and storage preferences, including compression and encryption of virtual private storage, information expiration, advanced filtering, and other critical controls on behalf of a specific user. The centralized autoconfiguration facilities can be used to set the autoconfiguration process for individual users or groups of users, thus making it a highly scalable network-wide administrative capability similar to what is used to administer software for a network of PCs or other devices.

A self-diagnostic manager in the behavior morphing unit 506 determines common errors and provides a fail-safe mechanism in the event the microchip implementation 500 for the virtual server application 116 is not operational for various reasons including, but not limited to, network, initialization, and other problems. This can be done without affecting the user's processing in the event that the policies cannot be determined. The behavior morphing unit 506 provides varying levels of diagnostic information to the audition service unit 508.

The load/store unit 504 is responsible for interfacing with the network in multiple locations and storage units using standard TCP/IP, high speed and low speed network, storage and memory protocols. The load/store unit 504 may communicate with web servers or other devices through network interfaces and firewalls. The load/store unit 504 can be aware of its own location. The load/store unit 504 may have a network controller function which can manage bandwidth allocation, download threads and other multiprocessing capabilities for information networking functions, such as retrieving and posting information to and from network resources. This core function of the load/store unit 504 is particularly useful with new generations of multiprocessing systems incorporating powerful dual- and multi-core processors with high bandwidth and processing capabilities. The network controller function also handles error recovery and instrumentation of requests to and from the network and storage units used in multiple locations, thus eliminating the need for manual user error handling.

The load/store unit 504 manages the transparent flow of information to and from a layered memory manager, the command unit 502, and the system network and storage hierarchies. The layered memory manager of the load/store unit 504 may have a multi-level cache controller designed using hierarchical virtual storage modeled after CPU multi-level cache design, but extending into indexed, encrypted, and compressible disk storage using integrated data caching techniques for management of keys, metadata, indexes, and virtual private storage. The load/store unit 504 is responsible for managing the integrity of the information, metadata, directory, and content flowing between the various internal units.

The command unit 502 may communicate with web clients (i.e., the browser and/or smart web client application 114 of the user's client computer 104). The command unit 502 in the core is responsible for managing the unique incoming and outgoing information requests between the web clients and the load/store unit 504. The requests are redirected to the command unit 502 based on the external autoconfiguration capabilities of the microchip implementation 500 for the virtual server application 116. The command unit 502 is reconfigurable by the behavior morphing unit 506. The command unit 502 also provides audit information to the audition service unit 508 based on the verbosity levels specified through runtime parameters or through the external autoconfiguration facilities. The command unit 502 interfaces with the layered memory manager of the load/store unit 504 to obtain and aggregate the information prior to responding to the requesting web client application through the response processor. Like other units, the command unit 502 is multi-threaded with a command dispatcher to the load/store unit 504. Results from the load/store unit 504 are aggregated, processed, and presented to any requesting web clients by the response processor and result aggregator functions in the command unit 502.

In the dynamic loadable services, the compression/decompression service unit 514 can manage the virtual private storage area on a disk of the client computer 104 using system-level dynamic compression and decompression algorithms based on unique key-based information of the types managed by the virtual services application 116. The compression/decompression service unit 514 may be reconfigurable using the policies and preferences specified through the external autoconfiguration facilities.

The cryptographic service unit 512 supports a virtual private storage area encrypted using a unique key, based on the user's computer login credentials. The cryptographic service unit 512 may be reconfigurable using the external autoconfiguration policies and preferences at the user level.

The directory service unit 510 is designed to store frequently-used directory entries in multiple locations. The directory service unit 510 operates independent from the directory services of the user's client computer 104. This application layer service can be used to virtualize and improve the reliability and performance of the location lookups frequently used by web client applications. A query manager in the directory service unit 150 interfaces with the command unit 502 in the core to process and resolve directory requests to the machine and network directory services. A directory manager in the directory service unit 510 interfaces with other directory services including, but not limited to, DNS services in the network and the client computer 104. The directory service unit 510 may interface with the load/store unit 504 to manage the information storage and network requests.

The audition service unit 508 can provide unique user profiling capability. This profiling capability provides for personalized, pre-aggregated, user-behavior profile reporting and instrumentation on a user-by-user basis including location-aware service level metrics. The profiling capability may also create personalized, encrypted data vaults or virtual repositories. The audition service unit 508 captures detailed, location-aware, historical user profile information for each user of the client computer 104 based on the history of connected and disconnected use of the virtualized information and application functions. The historical, pre-aggregated unique user profile can be used for security and compliance auditing; pre-fetch information distribution and pull optimization; information lifecycle management, location-aware service level analysis and application infrastructure optimization. Detailed clickstream data can be provided in a format compatible with industry-standard web logs, layered memory manager hit/miss statistics. Also provided can be location-aware, service-level metrics including network and applications failures, retries, successes and timings not available anywhere else, including at the request-level. These metrics can be for individual web objects of many types based on the context of information used by each unique user while operating in multiple locations and networks. The integrated, pre-aggregated historical information is provided by some or all of the units in the microchip implementation 500 for the virtual server application 114 based on autoconfiguration and runtime configuration options. The audition service unit 508 can have multiple levels of verbosity to provide increasing levels of diagnostic and timing information on the entire operation of the system and also the complete interaction between the web clients (browser, smart clients or other standard web clients) and the web database applications while connected or disconnected. These audition verbosity levels can be reconfigured using the external autoconfiguration capabilities and also runtime parameters. The audition service unit 508 fills a large void in capturing pre-aggregated, clickstream data with location-aware, unique-user aware service level metrics including service information from multiple local locations for portable and mobile devices.

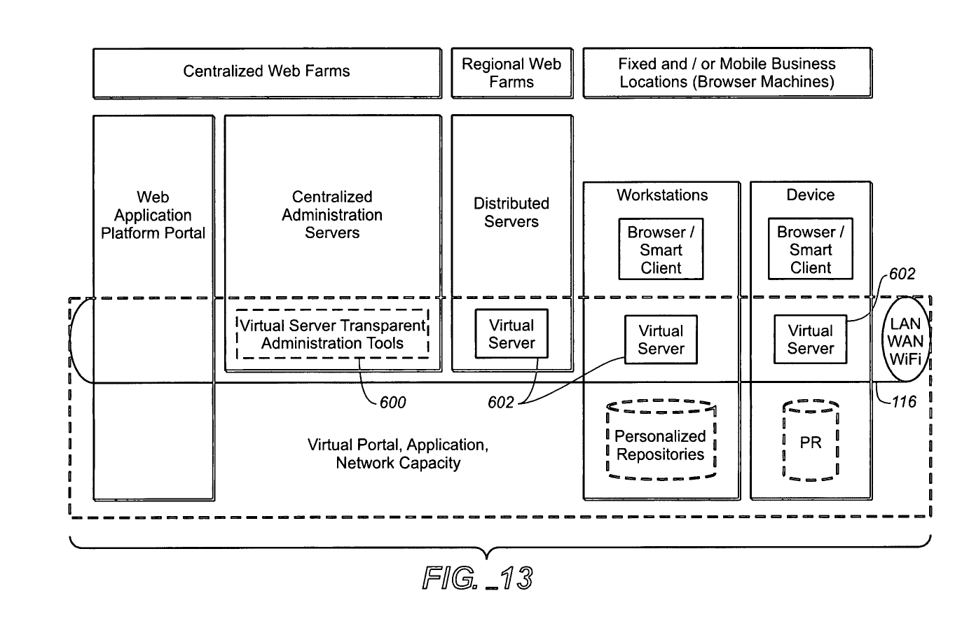

FIG. 13 illustrates scalable deployment of a virtual server application 116 for demand driven personalization, according to an embodiment of the present invention. As depicted, components of the virtual server application 116 are deployed throughout various hardware in the web architecture implementation including centralized administration servers; distributed servers; and workstations, devices, or other client computers. These components of the virtual server application 116 may include transparent administration tools using standard mechanisms for staging and distributing software packages and auto-configuration script components running on one or more centralized administration servers. The components may also include multi-threaded virtual servers 602 running on distributed servers, workstations, and other enterprise or consumer user devices. These various components of the virtual server application 116 can each be implemented as software applications, routines, sub-routines, processes, tools, and the like, and/or suitable hardware (e.g., a microchip implementation). The components of the virtual server application 116 residing on the centralized administration servers, distributed servers, workstations and other user devices may cooperate to deliver the functionality described herein, providing guided installation, configuration, and operation. These components may communicate with each other via a local area network (LAN), wide area network (WAN), virtual private network (VPN), wireless (WiFi) network, satellite network, or any other suitable links.

This superpipelined virtual architecture with integrated functions ensures a high rate of hits against frequently-used data for web site navigation and unique (yet repetitive) searches by employing a layered memory manager for information and application logic with automatic migration of information from disk storage to different levels of in-memory caches. The local virtual storage is private for each user on a specific workstation, personal computer (PC), kiosk, terminal, or other like user device. Still, many browser and/or smart web client application devices can be shared between multiple users. The virtual server application 116 protects each user's private personalized web pages using encryption and other techniques. This web architecture implementation safeguards the data against unauthorized access by another user on the same user device or from a theft of such device.

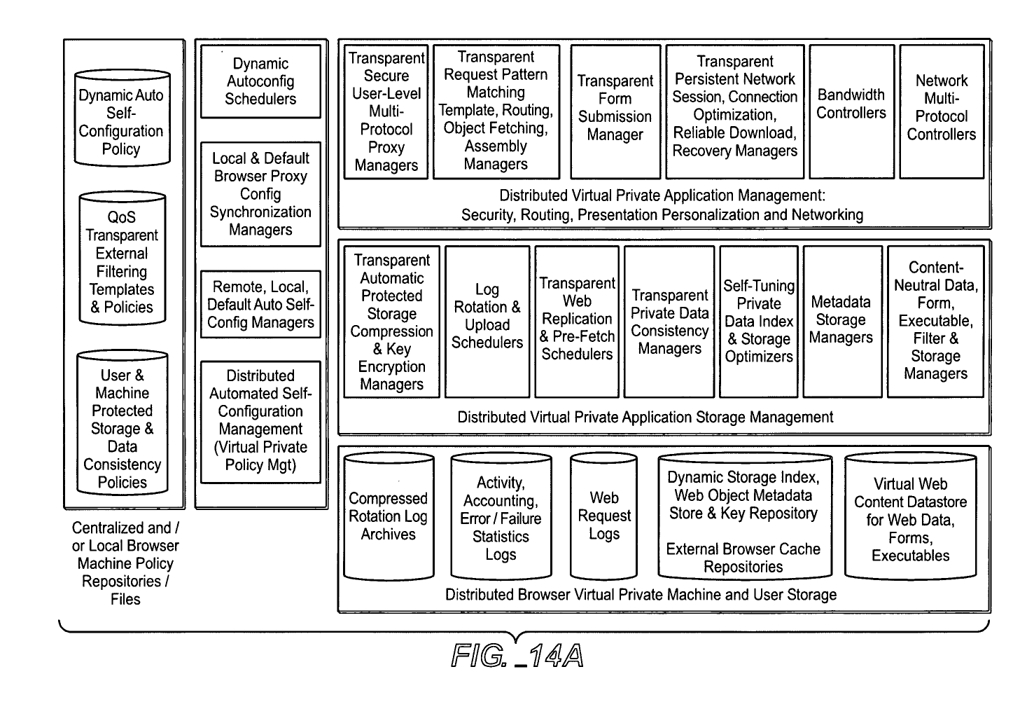

FIGS. 14A and 14B are diagrams illustrating implementations for management, storage, and configuration components for a virtual server application 116, according to embodiments of the present invention. These components can include a virtual private application management component, a virtual private self-protected application storage management component, and a virtual private application policy management component, each of which may itself be implemented as a plurality of other components. Virtual repositories may be provided on the user devices and the centralized web computing resources for the virtual server application 116. These virtual repositories may also include various components and databases.

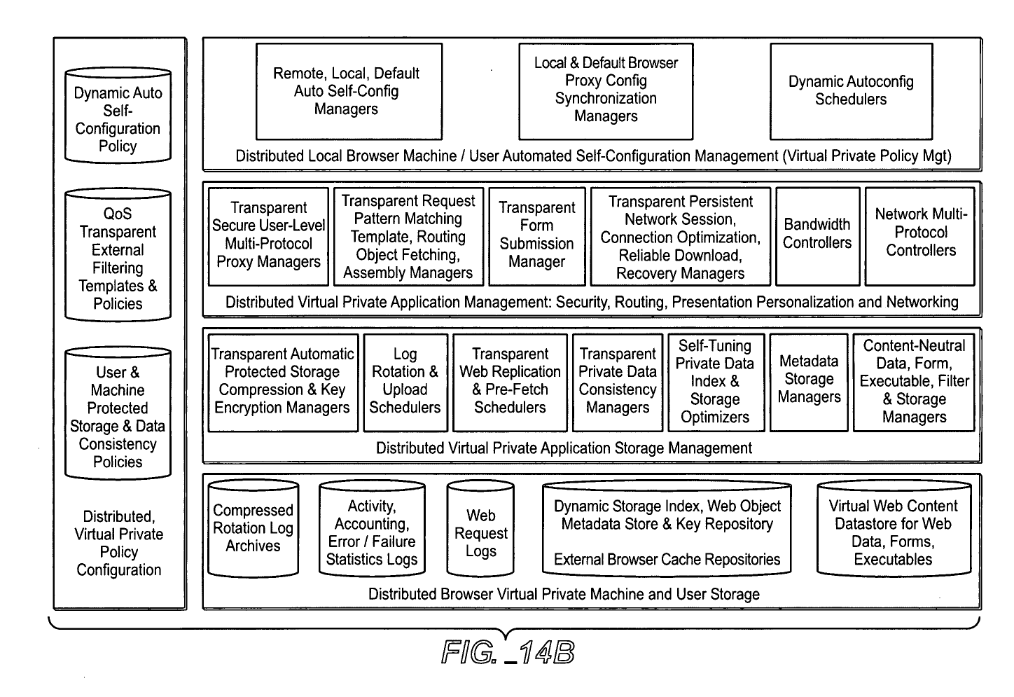

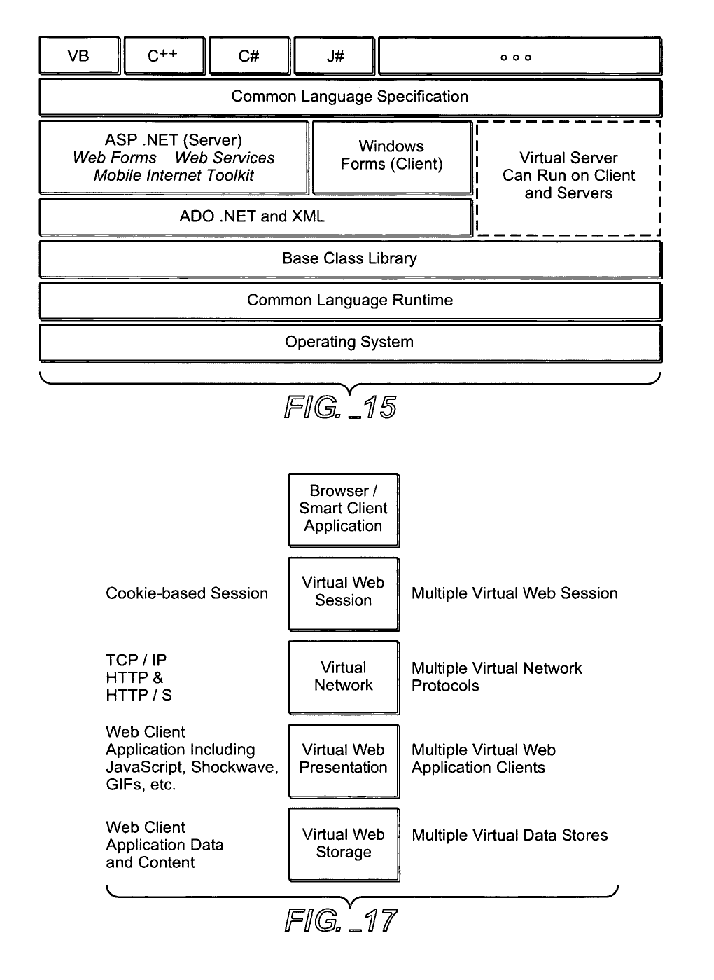

FIG. 15 is a diagram for an exemplary runtime infrastructure for servers and devices, according to an embodiment of the present invention. As shown in FIG. 15, in one embodiment, the virtual server application 116 can be implemented as code at the server application layer on both client devices and servers. Such application layer is standard in web servers, but not on browser and/or smart web client machines (e.g., PCs, PDAs or other user devices). The virtual server application 116 thus virtualizes the centralized or distributed server application layer in client devices. As such, the virtual server application 116, according to various embodiments, may leverage common infrastructure and routines.

FIGS. 16A and 16B illustrate the virtualization of various layers of multiple web transactions, according to an embodiment of the present invention. In particular, various layers of a web transaction session can be virtualized. For example, when a browser and/or smart web client application 114 resident on an enterprise user client computer 104 (e.g., browser machine) interacts with the virtual server application 116 on the same device, the user and/or the device may believe that it is involved in a session with one or more network-based server machines (e.g., Server Machines A and B) at the centralized web computing resources 102 of the enterprise. During such sessions, data, and presentation material may seem to be transported between the server machines and the browser machine. This is shown in FIG. 16A. However, this interaction is virtual, because it is the virtual server application 116 on the user device and not the Server Machines A and B, which is providing the data and presentation and carrying on the “transport.” Thus, the layers which may be virtualized on a per user basis by embodiments of the present invention can be application, presentation, session, transport and network, as shown in FIG. 16B.

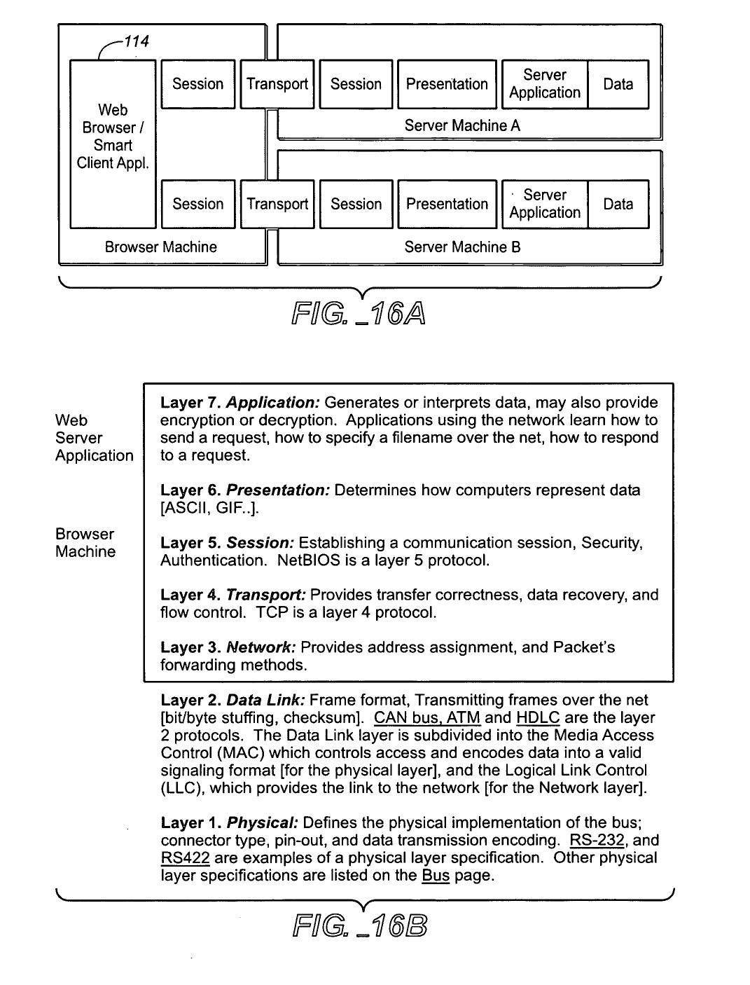

FIG. 17 is illustrates multiple virtual web management, according to an embodiment of the present invention. In particular, embodiments of the present invention can manage the virtual application and network layers including, for example, a virtual web session, virtual network, virtual web presentation, and virtual web storage. Virtual web sessions enabled by embodiments of the present invention can be generally categorized as virtual private applications (VPA) and virtual private personalized applications (VPPA). Virtual private applications can relate to, for example, policy management and networking (which may be responsible for virtual session management). Virtual private personalized applications can be user-specific. The applications can relate to, for example, private smart client, smart client, web application clients (forms, navigation), web client searches (queries, etc.), web client browsing (non-application website using files as content), workplace, web transactions (forms management), personalized applications, portals, application session, web presentation management, private information management, private storage management, and private personalized information management.

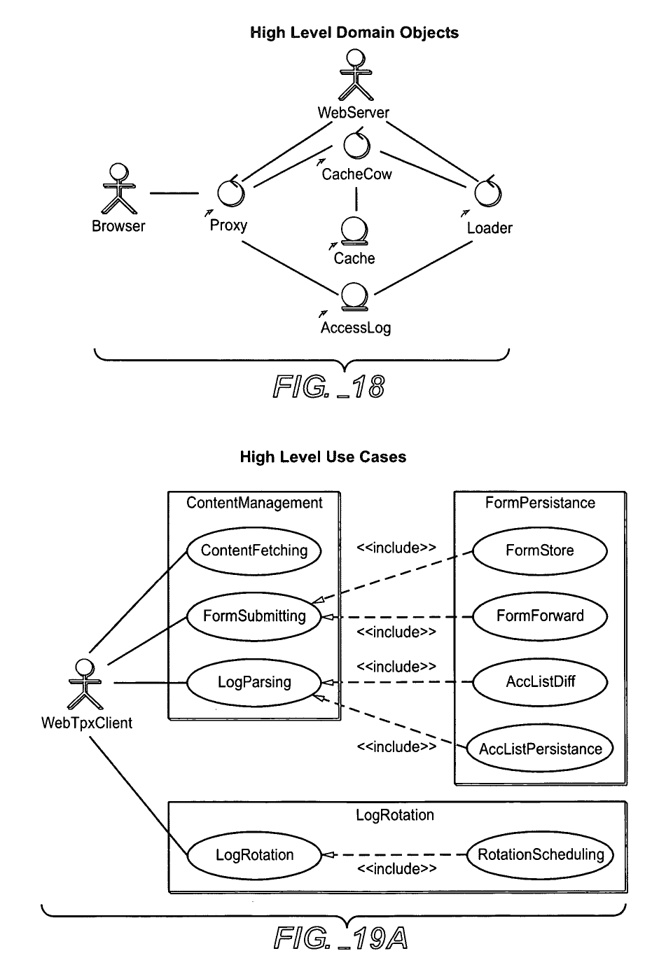

FIG. 18 illustrates exemplary domain objects, according to an embodiment of the present invention. In the systems, architectures, and methods according to various embodiments, one or more of domain objects may be used in operation. These domain objects may include, for example, proxy, cache, cache cow, access log, and loader. These domain objects can be implemented using microchip design techniques supporting single-, dual-, and multi-processing architectures.

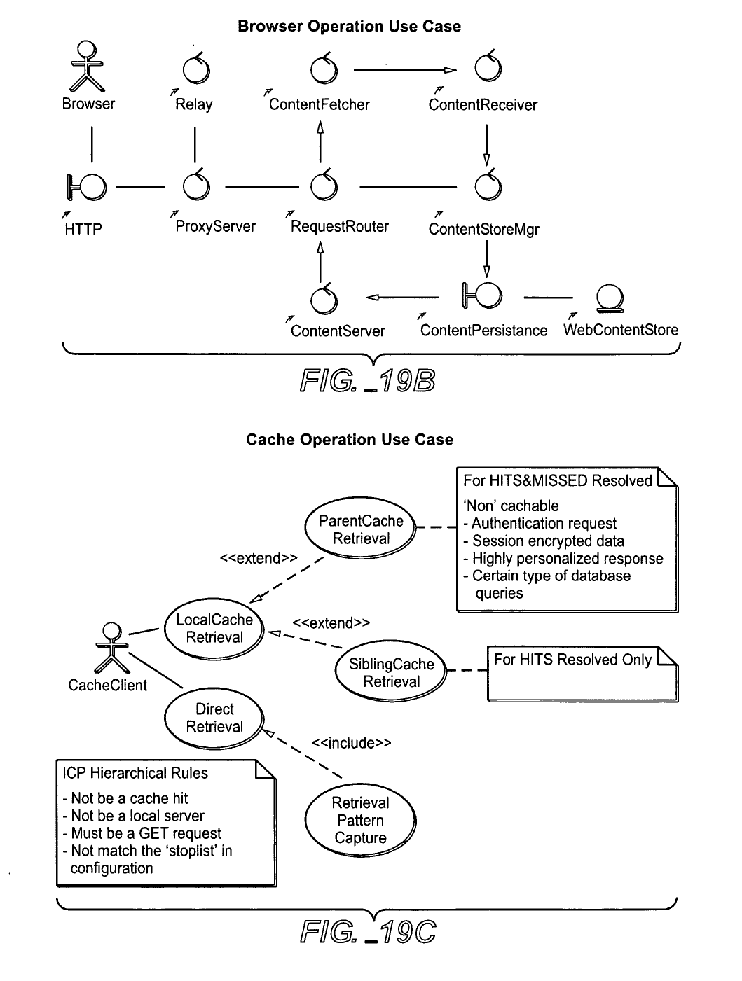

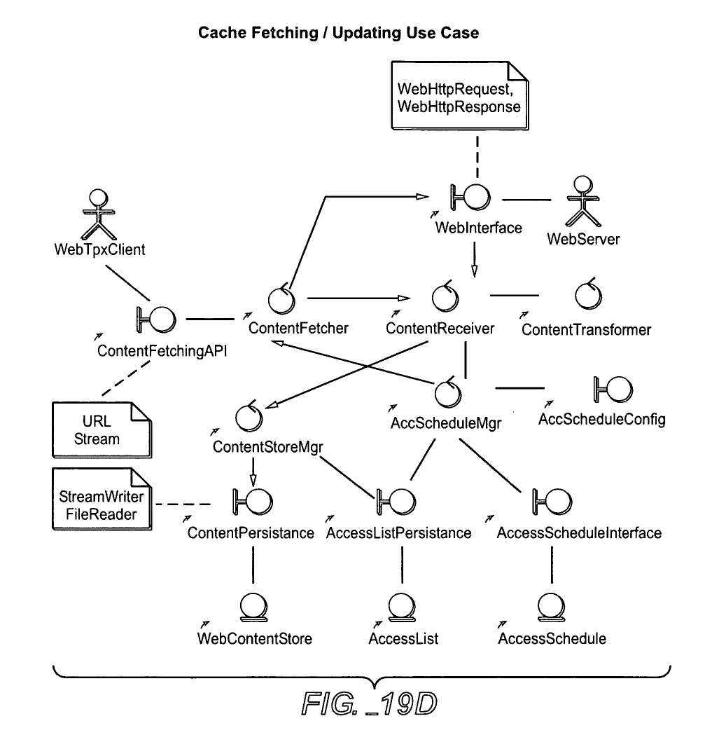

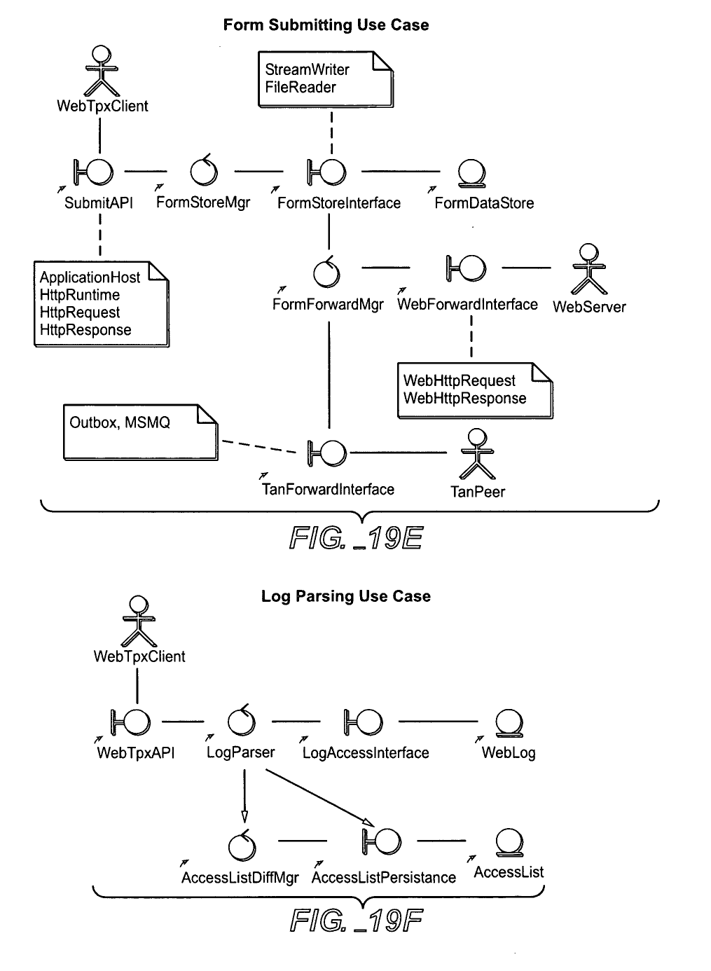

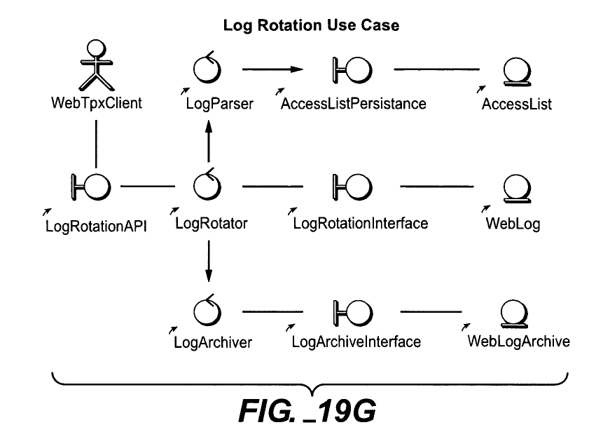

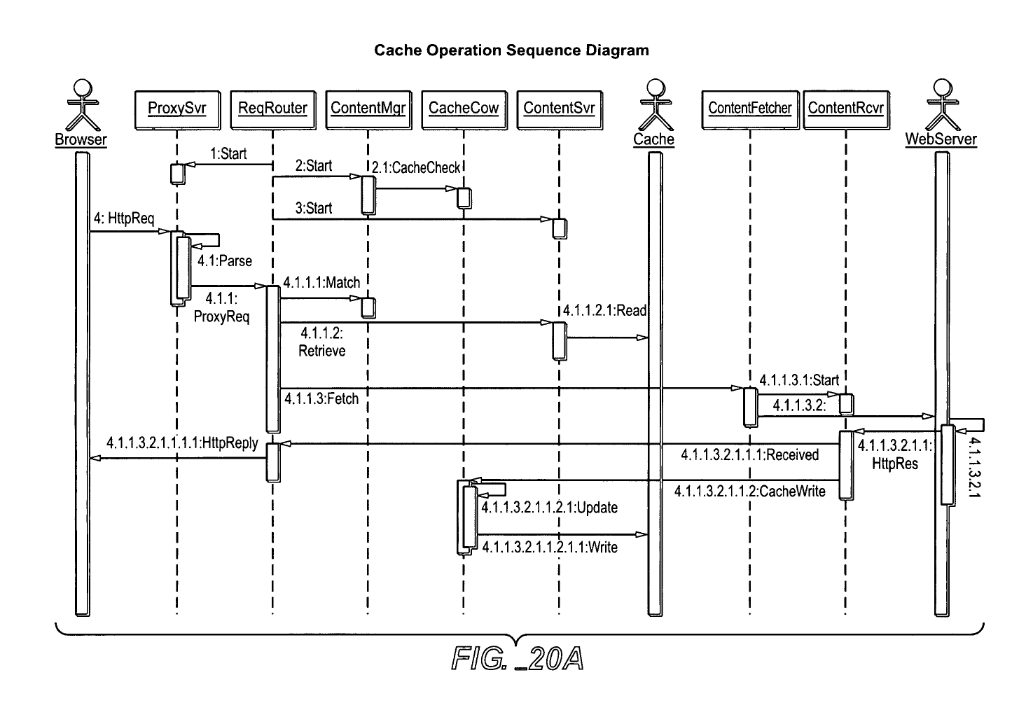

FIGS. 19A through 19G illustrate exemplary use cases, according to embodiments of the present invention. Operations in the systems, architectures, and methods according to various embodiments can be represented as use cases. Use cases may be provided for such operations as browser and/or smart web client operation, layered memory cache operation, cache fetching/updating, form submitting, log parsing, and log rotation.

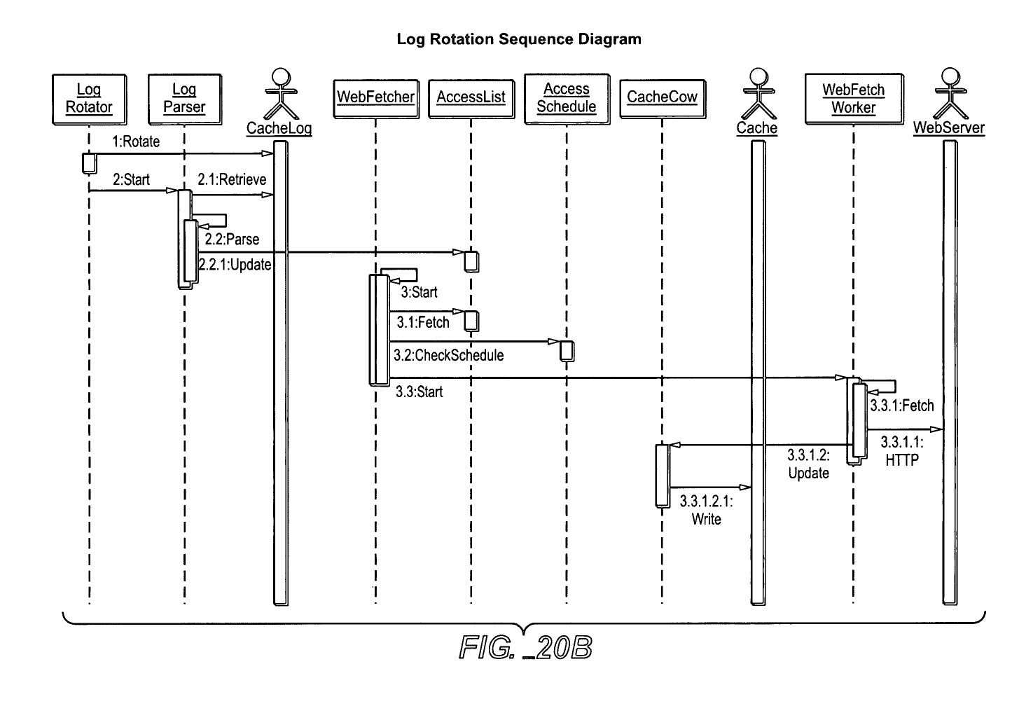

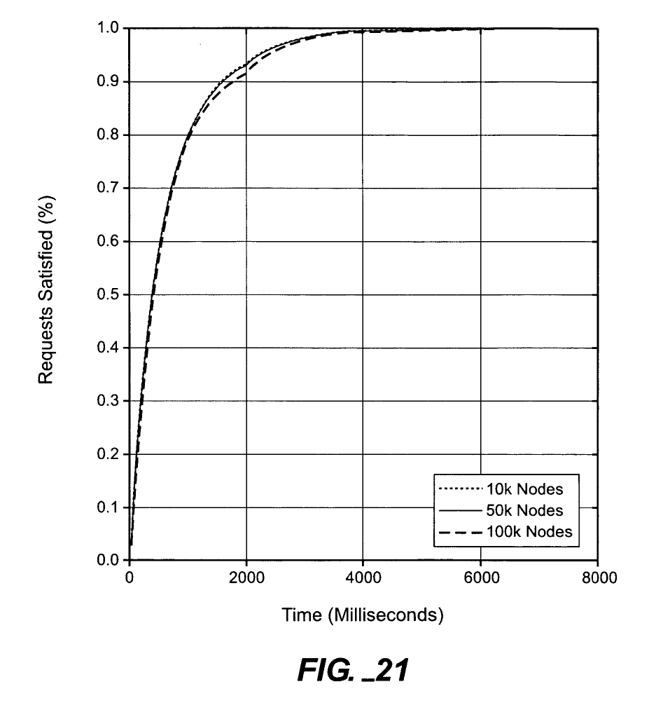

FIGS. 20A and 20B illustrate exemplary sequence diagrams, according to embodiments of the present invention. Some of the operations in the systems, architectures, and methods according to various embodiments can also be represented in the form of sequence diagrams.

FIG. 21 is a diagram illustrating expected scalabity of a web architecture implementation, according to an embodiment of the present invention. The web architecture implementation, which is designed based on a superscalar, superpipelined and superthreaded core with integrated functions, may be deployed on many enterprise user devices, thus making each user device a “node” in the system and/or network. Furthermore, the node can have affinity to one logical or physical CPU in a dual- or multi-core multiprocessing system while web clients operate in one or more cores. The web architecture implementation can support thousands of nodes without degradation in performance.

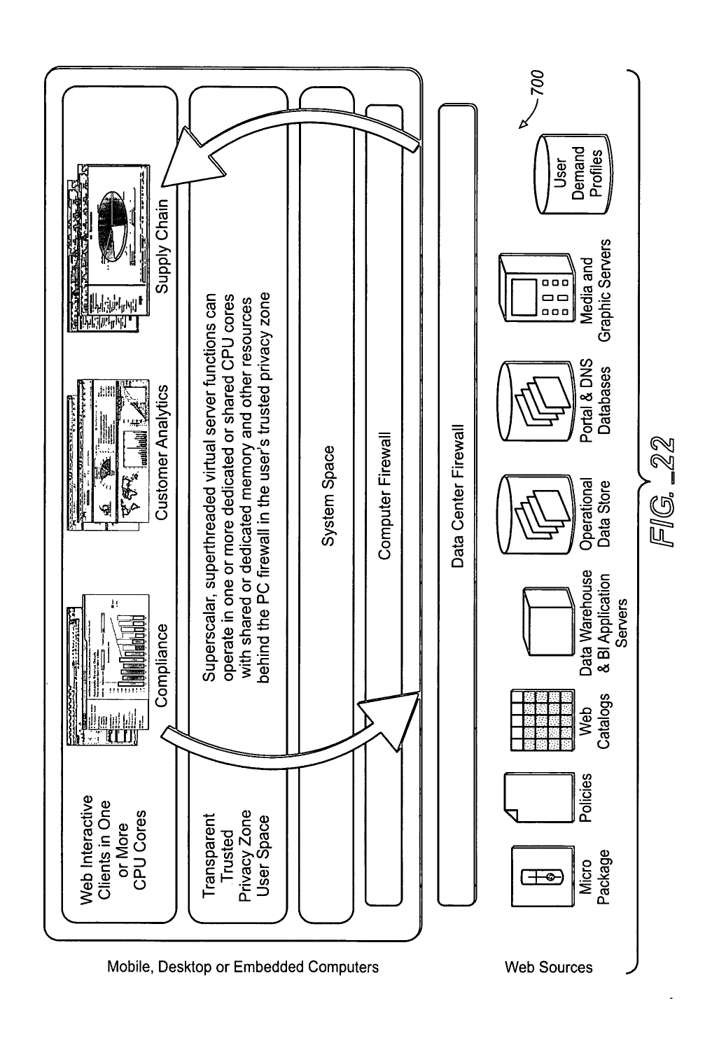

FIG. 22 illustrates an exemplary platform 700, according to an embodiment of the present invention. In one embodiment, the virtual server application 116 (such as the superscalar, superpipelined, and superthreaded microchip implementation) operates in the user space on behalf of individual users, thereby providing simultaneous virtual and real networking and other services. The virtual server application can be reconfigured to support multiple processing configurations, including dedicated functions to specific CPU cores and resources or functions operating in parallel in multiple or dedicated CPU cores.

The microchip implementation for the virtual server application 116 can optimize the use of the web architecture for simultaneous multi-threaded processing of multiple functions on dual- and multi-core processors with minimal latencies as network, memory, and storage bandwidth increases and parallel CPU speeds increase. Users of highly personalized public and private Internet database applications can efficiently use the database-driven application and information behind a device or PC firewall while connected or disconnected from the physical network, operating in multiple locations.

After a complete information processing cycle has been completed at least once with the central sites, the interactive, personalized session is virtualized for specific information or pre-fetched based on policies associated with using the prior information processing cycle history of the specific user. The personalized private information and application logic is captured on the device for use behind the firewall in a trusted private secure zone (privacy zone). The transparent use of the system and methods of the current invention provide users with the ability to process information privately behind the PC firewall in a trusted security zone simultaneously and in parallel on new or existing uniprocessing and multiprocessing notebook, desktop, mobile or embedded devices with minimal latencies as bandwidth and processing power increases. The virtualized interactive database applications can be used in multiple locations with pre-aggregated profiles of information use and location-aware service level metrics captured.

The weaknesses of previously developed systems and methods are substantially reduced or eliminated by embodiments of the present invention as described herein. Such weaknesses include degradation in file synchronization and compression, the need for distributed server platforms or proprietary appliances, longer deployment cycles due to non-standard equipment/tools/administration, single points of failure and/or bottlenecks, the need for specialized training of technical staff and finally inadequate application performance. Systems, architectures, and methods, according to one embodiment, also reduce the need to redevelop web applications, enrich web applications to behave like client/server applications with the same speed and usability, and support portable and mobile devices and uses while disconnected from the web.

As described herein, the distributed executables, metadata, data and content management architecture is designed to scale to support the needs of large information consumers using any computer or network. Hundreds, thousands or millions of devices can run the personalized multi-threaded Virtual servers with integrated functions that dynamically adapt to the unique data needs of each and every user. The adaptive software is self-tuning and self-configuring by design to continuously optimize the distributed local storage based on the unique needs of each user without user or administrator intervention. The self-configuring, self-tuning behavior is controlled by central enterprise policies for security, executables, directory, metadata, data and content consistency and it is configurable to a machine, user, group or enterprise level. The self-healing algorithms include default behaviors to continue operating in the event of a network failure where the auto-configuration capabilities cannot be invoked to access the centralized enterprise policies. These distributed algorithms combine to form self-stabilizing configuration capabilities to provide fault tolerance and fail-safe modes of operation for each Virtual server.

Although the present invention and its advantages have been described in detail, it should be understood that various changes, substitutions, and alterations can be made therein without departing from the spirit and scope of the invention as defined by the appended claims. That is, the discussion included in this application is intended to serve as a basic description. It should be understood that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Neither the description nor the terminology is intended to limit the scope of the claims.

1. A computer system comprising:
at least one web server having content that is personalized for a user; and
a user device operable to be used by the user, the user device having a browser application and a virtual server application, the browser application operable to retrieve the personalized content from the at least one web server upon a first request by the user, the virtual server application to provide the personalized content to the browser application upon a second request by the user.

2. The computer system of claim 1 wherein the virtual server application is implemented as a microchip.

3. The computer system of claim 1 wherein the personalized content comprises at least one of an executable application, a directory, metadata, and data.

4. The computer system of claim 1 wherein the virtual server application is operable to automatically obtain updates for the personalized content from the at least one web server.

5. The computer system of claim 1 wherein the user device comprises a private repository operable to store the personalized content.

6. The computer system of claim 1 wherein the private repository resides behind a firewall for the user device.

7. The computer system of claim 1 where in the user device comprises one of a client computer, a workstation, and a personal digital assistant.
